(19) United States
(12) Patent Application Publication
(10) Pub. No.: US 2017/0061046 A1
(43) Pub. Date: Mar. 2, 2017

(54) SIMULATION DEVICE OF SEMICONDUCTOR DEVICE AND SIMULATION METHOD OF SEMICONDUCTOR DEVICE

(71) Applicant: KABUSHIKI KAISHA TOSHIBA, Minato-Ku (JP)

(72) Inventor: Ai OMODAKA, Yokkaichi (JP)

(73) Assignee: KABUSHIKI KAISHA TOSHIBA, Minato-Ku (JP)

(21) Appl. No.: 15/061,179

(22) Filed: Mar. 4, 2016

Related U.S. Application Data
(60) Provisional application No. 62/212,856, filed on Sep. 1, 2015.

(51) Int. Cl. G06F 17/50

(52) U.S. Cl. CPC G06F 17/5009; G06F 17/5081

(57) ABSTRACT

A simulation device of a semiconductor device according to an embodiment is a simulation device for analyzing a structural defect of the semiconductor device, the semiconductor device having wiring lines disposed three-dimensionally therein, and the simulation device of the semiconductor device comprises: a correct structure acquiring unit that acquires a correct structure of the semiconductor device; a comparative structure acquiring unit that acquires a comparative structure, the comparative structure being a structure of the semiconductor device manufactured under a certain condition; a difference extracting unit that extracts a difference of the comparative structure with respect to the correct structure; and a defect determining unit that determines a defect of the comparative structure from the difference, the defect determining unit including an open/short attribute determining unit that determines whether the difference is an open attribute positioned inside the correct structure or a short attribute positioned outside the correct structure.

### CROSS-REFERENCE TO RELATED APPLICATIONS

This application is based upon and claims the benefit of priority from the prior U.S. Provisional Application 62/212,856, filed on Sep. 1, 2015, the entire contents of which are incorporated herein by reference.

### BACKGROUND

Field

Embodiments of the present invention relate to a simulation device of a semiconductor device and a simulation method of the semiconductor device.

Description of the Related Art

Many semiconductor devices include a plurality of wiring lines disposed three-dimensionally, and in recent years, wiring line structures of those semiconductor devices have been becoming increasingly miniaturized and complicated. For example, in the case of flash memories, in order to dispose many word lines in a limited area, a structure in which the word lines are disposed over a plurality of layers, and so on, has also been proposed. Moreover, when developing semiconductor devices that are becoming complex in this way, it is a problem in terms of cost and time to repeat from wiring line design to trial manufacture every time a wiring line abnormality is found.

### BRIEF DESCRIPTION OF THE DRAWINGS

FIG. 1 is a view showing functional blocks of a semiconductor device according to a first embodiment.

FIG. 2 is an equivalent circuit diagram of a memory cell array in the semiconductor device according to the same embodiment.

FIGS. 3 and 4 are perspective views showing a schematic structure of the memory cell array in the semiconductor device according to the same embodiment.

FIG. 5 is a functional block diagram of a simulation device of the semiconductor device according to the same embodiment.

FIG. 6 is a functional block diagram of an arithmetic unit of the simulation device of the semiconductor device according to the same embodiment.

FIG. 7 is a flowchart of a main routine in a simulation method of the semiconductor device according to the same embodiment.

FIG. 8 is a flowchart of margin amount acquisition in the simulation method of the semiconductor device according to the same embodiment.

FIG. 9 is a perspective view of a correct structure in the simulation method of the semiconductor device according to the same embodiment.

FIGS. 10 and 11 are conceptual views of margin amount acquisition in the simulation method of the semiconductor device according to the same embodiment.

FIG. 12 is a conceptual view of generation of a structure-to-be-analyzed in the simulation method of the semiconductor device according to the same embodiment.

FIG. 13 is a perspective view of the structure-to-be-analyzed in the simulation method of the semiconductor device according to the same embodiment.

FIG. 14 is a conceptual view of numbering of the structure-to-be-analyzed in the simulation method of the semiconductor device according to the same embodiment.

FIG. 15 is a conceptual view of search of an overlapping place between wiring lines of the structure-to-be-analyzed in the simulation method of the semiconductor device according to the same embodiment.

FIGS. 16A to 16C are conceptual views of a simulation method of a semiconductor device according to a second embodiment.

FIG. 17 is a functional block diagram of an arithmetic unit of a simulation device of the semiconductor device according to the same embodiment.

FIG. 18 is a flowchart of a main routine in the simulation method of the semiconductor device according to the same embodiment.

FIG. 19 is a flowchart of defect determination in the simulation method of the semiconductor device according to the same embodiment.

FIG. 20 is a flowchart of open/short attribute determination in the simulation method of the semiconductor device according to the same embodiment.

FIG. 21 is a flowchart of risk determination in the simulation method of the semiconductor device according to the same embodiment.

FIG. 22 is a flowchart of criticality determination in the simulation method of the semiconductor device according to the same embodiment.

FIG. 23 is a flowchart of risk degree determination in the simulation method of the semiconductor device according to the same embodiment.

FIGS. 24A to 24D are conceptual views of open/short attribute determination in the simulation method of the semiconductor device according to the same embodiment.

FIGS. 25A to 25D are conceptual views of open/short attribute determination in the simulation method of the semiconductor device according to the same embodiment.

FIGS. 26A to 26D are conceptual views of open/short attribute determination in the simulation method of the semiconductor device according to the same embodiment.

FIGS. 27A to 27D are conceptual views of open/short attribute determination in the simulation method of the semiconductor device according to the same embodiment.

FIGS. 28A to 28F are conceptual views of criticality determination in the simulation method of the semiconductor device according to the same embodiment.

FIGS. 29A to 29F are conceptual views of criticality determination in the simulation method of the semiconductor device according to the same embodiment.

FIGS. 30A to 30F are conceptual views of criticality determination in the simulation method of the semiconductor device according to the same embodiment.

FIGS. 31A to 31F are conceptual views of criticality determination in the simulation method of the semiconductor device according to the same embodiment.

FIGS. 32A to 32J are conceptual views of criticality determination in the simulation method of the semiconductor device according to the same embodiment.

FIGS. 33A to 33J are conceptual views of criticality determination in the simulation method of the semiconductor device according to the same embodiment.

FIG. 34A to 34F are conceptual views of risk degree determination in the simulation method of the semiconductor device according to the same embodiment.

FIG. 35A to 35F are conceptual views of risk degree determination in the simulation method of the semiconductor device according to the same embodiment.

### DETAILED DESCRIPTION

A simulation device of a semiconductor device according to an embodiment is a simulation device for analyzing a structural defect of the semiconductor device, the semiconductor device having a plurality of wiring lines disposed three-dimensionally therein, and the simulation device of the semiconductor device comprises: a correct structure acquiring unit that acquires a correct structure of the wiring lines of the semiconductor device; a comparative structure acquiring unit that acquires a comparative structure, the comparative structure being a structure of the wiring lines of the semiconductor device manufactured under a certain condition; a difference extracting unit that extracts a difference of the comparative structure with respect to the correct structure; and a defect determining unit that determines a defect of the comparative structure from the difference, the defect determining unit including an open/short attribute determining unit that determines whether the difference is an open attribute positioned inside the correct structure or a short attribute positioned outside the correct structure.

Simulation devices of semiconductor devices and simulation methods of the semiconductor devices according to embodiments will be described below with reference to the drawings.

### First Embodiment

First, as a prerequisite of describing a simulation device of a semiconductor device and a simulation method of the semiconductor device according to a first embodiment, an example of the semiconductor device employed in the description of the present embodiment below, will be described.

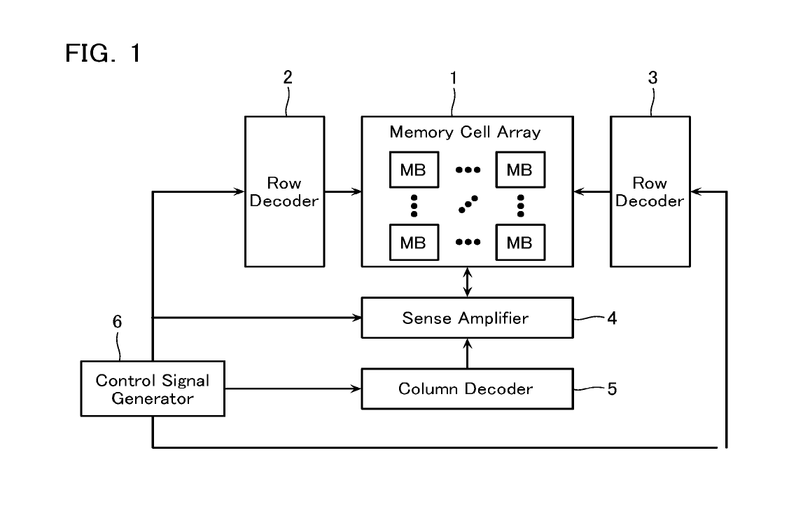

FIG. 1 is a view showing functional blocks of the semiconductor device according to the present embodiment.

The semiconductor device shown here is an example of a flash memory having a three-dimensional structure in which memory cells are connected in series in a perpendicular direction to a principal plane of a semiconductor substrate.

The semiconductor device of FIG. 1 comprises: a memory cell array 1; row decoders 2 and 3; a sense amplifier 4; a column decoder 5; and a control signal generator 6. The memory cell array 1 includes a plurality of memory blocks MB. Each of the memory blocks MB includes a plurality of memory cells MC that are arranged three-dimensionally. The row decoders 2 and 3 decode a downloaded block address signal, and so on, and control a write operation and a read operation of data of the memory cell array 1. The sense amplifier 4 detects and amplifies an electrical signal flowing in the memory cell array 1 during the read operation. The column decoder 5 decodes a column address signal and controls the sense amplifier 4. The control signal generator 6, as well as boosting a reference voltage and generating a high voltage employed during the write operation or an erase operation, generates a control signal, and controls the row decoders 2 and 3, the sense amplifier 4, and the column decoder 5.

Next, a circuit configuration of the memory cell array 1 will be described.

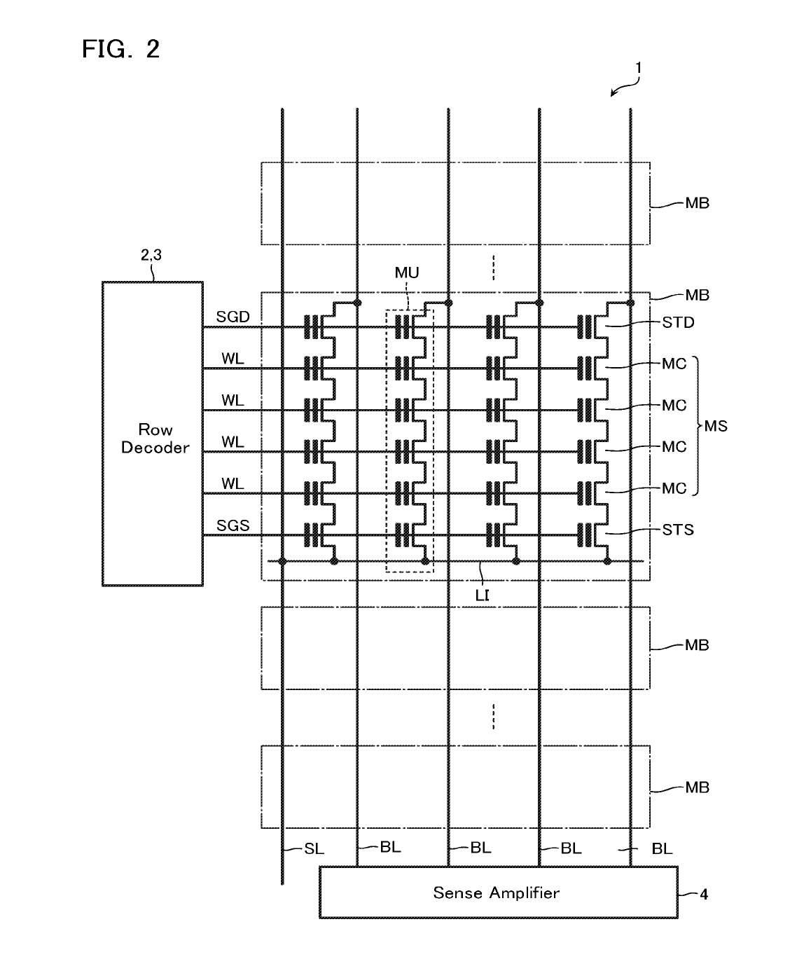

FIG. 2 is an equivalent circuit diagram of the memory cell array in the semiconductor device according to the present embodiment.

As shown in FIG. 2, the memory cell array 1 includes a plurality of the memory blocks MB. Commonly connected to these plurality of memory blocks MB are a plurality of bit lines BL and a source line SL. Each of the memory blocks MB is connected to the sense amplifier 4 via the bit lines BL and is connected to an unillustrated source line driver via the source line SL.

The memory block MB includes a plurality of memory units MU, whose one ends are connected to the bit lines BL, and whose other ends are connected to the source line SL via a source contact LI. Each of the memory units MU includes: a memory string MS; a source side select transistor STS connected between the memory string MS and the source contact LI; and a drain side select transistor STD connected between the memory string MS and the bit line BL.

The memory string MS includes a plurality of the memory cells MC connected in series. Each of the memory cells MC is a transistor having a semiconductor layer, a charge accumulation layer, and a control gate, and accumulates a charge in the charge accumulation layer according to a voltage applied to the control gate, thereby changing a threshold value of the memory cell MC. Commonly connected to the control gates of pluralities of the memory cells MC belonging to different memory strings MS are, respectively, the word lines WL. These pluralities of memory cells MC are connected to the row decoder 2 or 3 via the word lines WL.

The source side select transistor STS has a control gate to which a source side select gate line SGS is connected. The source side select gate line SGS is connected to the row decoder 2 or 3, and selectively connects the memory string MS and the semiconductor substrate, based on an inputted signal.

The drain side select transistor STD has a control gate to which a drain side select gate line SGD is connected. The drain side select gate line SGD is connected to the row decoder 2 or 3, and selectively connects the memory string MS and the bit line BL, based on an inputted signal.

Next, a schematic structure of the memory cell array 1 will be described.

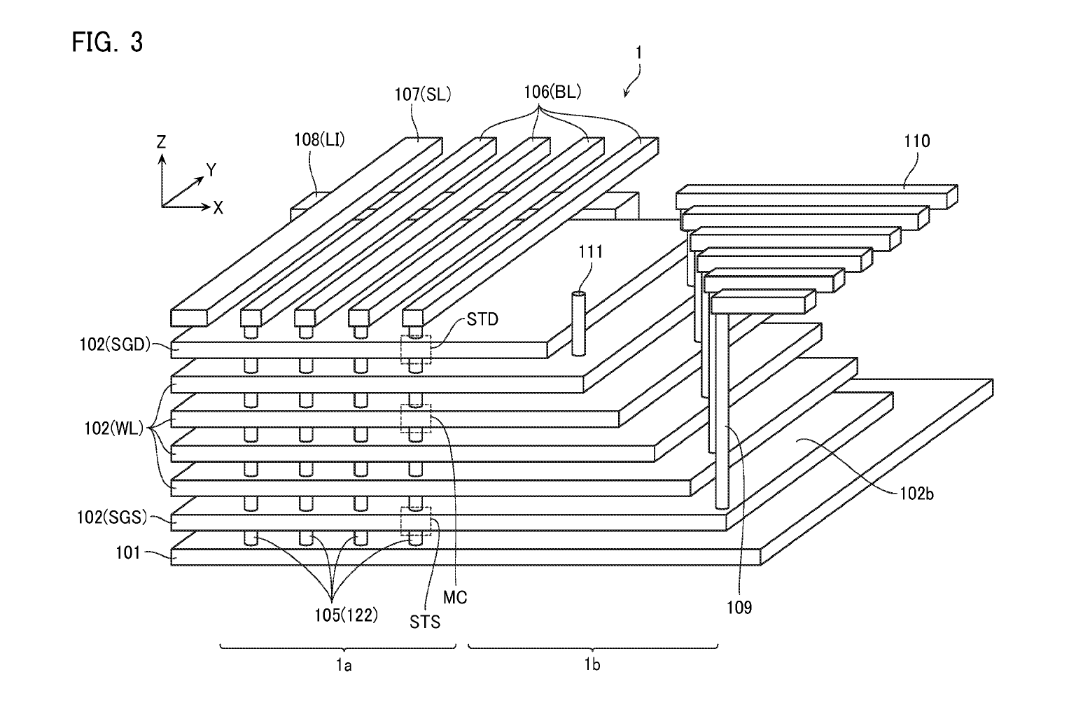

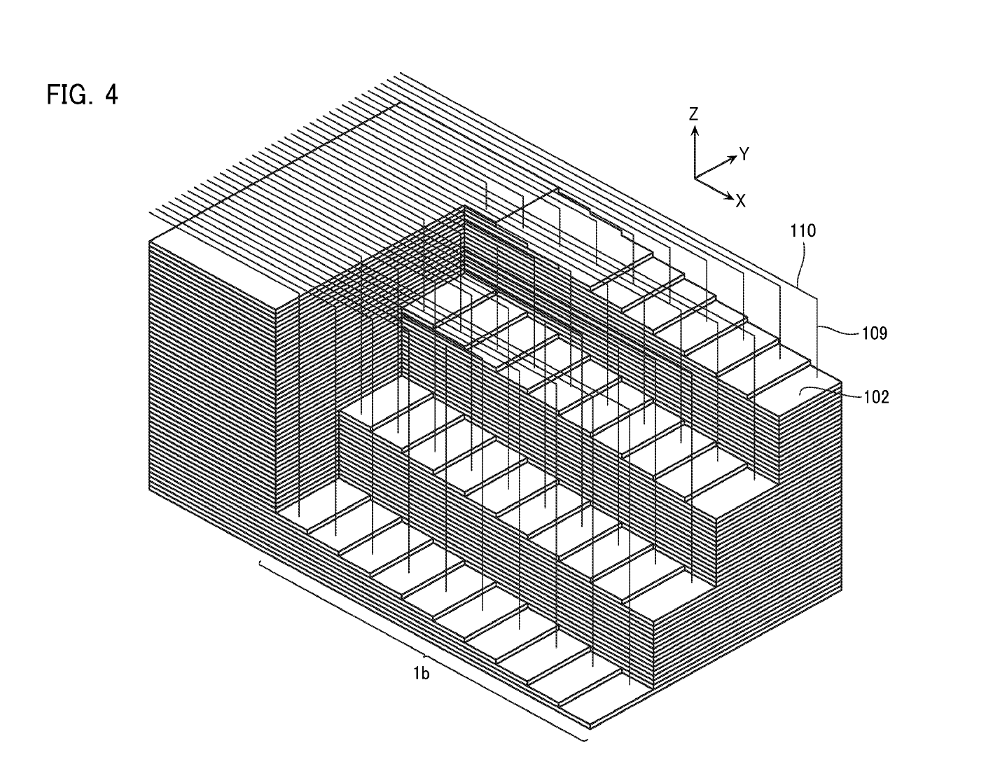

FIGS. 3 and 4 are perspective views showing the schematic structure of the memory cell array in the semiconductor device according to the present embodiment.

As shown in FIG. 3, the memory cell array 1 includes: a semiconductor substrate 101; and a plurality of conductive layers 102 stacked in a Z direction (stacking direction) on the semiconductor substrate 101.

In addition, the memory cell array 1 includes a plurality of memory columnar bodies 105 extending in the Z direction. An intersection of the conductive layer 102 and the memory columnar body 105 functions as the source side select transistor STS, the memory cell MC, or the drain side select transistor STD. The conductive layer 102 is formed from the likes of tungsten (W) or polysilicon (Poly-Si), for example, and functions as the source side select gate line SGS, the word line WL, or the drain side select gate line SGD.

The plurality of conductive layers 102 are formed in steps. That is, a certain conductive layer 102 has a contact portion 102b that does not face a lower surface of another conductive layer 102 positioned in a layer above it. Moreover, the conductive layer 102 is connected to a via 109 at this contact portion 102b. A wiring line 110 is disposed at an upper end of the via 109. Note that the via 109 and the wiring line 110 are formed from the likes of tungsten (W), for example.

In addition, the memory cell array 1 includes a conductive layer 108 that faces side surfaces in a Y direction of the plurality of conductive layers 102, and extends in an X direction. A lower surface of the conductive layer 108 contacts the semiconductor substrate 101. The conductive layer 108 is formed from the likes of tungsten (W), for example, and functions as the source contact LI.

Moreover, the memory cell array 1 includes a plurality of conductive layers 106 and a conductive layer 107 that are positioned above the plurality of conductive layers 102 and memory columnar bodies 105, are arranged in plurality in the X direction, and extend in the Y direction. The memory columnar bodies 105 are respectively connected to lower surfaces of the conductive layers 106. Note that the conductive layer 106 is formed from the likes of tungsten (W), for example, and functions as the bit line BL. The conductive layer 108 is electrically connected to a lower surface of the conductive layer 107. Note that the conductive layer 107 is formed from tungsten (W), for example, and functions as the source line SL.

Furthermore, the memory cell array 1 includes a beam columnar body 111. The beam columnar body 111 supports a posture of an unillustrated inter-layer insulating layer disposed between the conductive layers 102, in a manufacturing step.

Now, FIG. 3 showed the structure of the memory cell array 1 simplified for ease of understanding, but, for example, in the case of a memory cell array 1 including 64 layers of conductive layers 102, a wiring line structure of the contact portions 102b thereof becomes miniaturized and complicated as shown in FIG. 4. This is particularly marked in the case of the semiconductor device having a three-dimensional structure of a plurality of wiring lines disposed three-dimensionally described thus far. Therefore, during development of such a semiconductor device, it is difficult for analysis of a critical defect of wiring line structure or a risk degree to be performed by a human. In that respect, being able to simulate such analysis mechanically by the likes of a calculator leads to a reduction of development cost.

Accordingly, in the present embodiment, the following kind of simulation device for analyzing a structural defect of the semiconductor device, is employed.

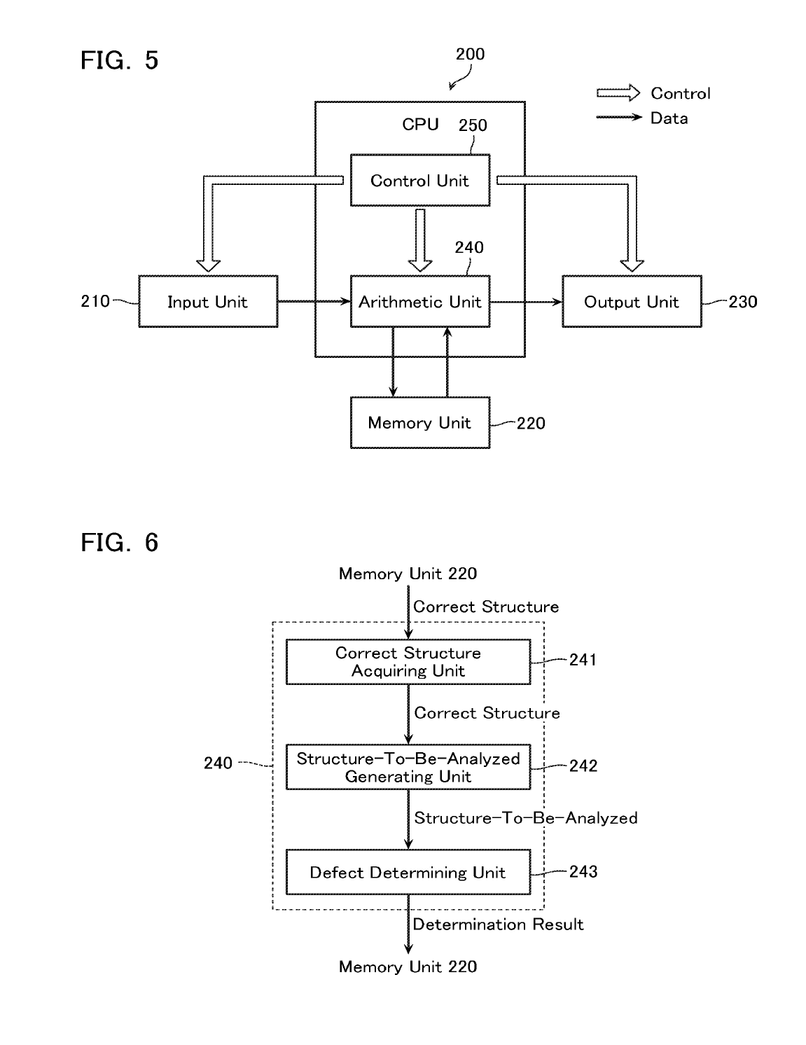

FIG. 5 is a functional block diagram of the simulation device of the semiconductor device according to the present embodiment. Solid line arrows in FIG. 5 indicate a flow of data, and outline arrows in FIG. 5 indicate a control relationship.

A simulation device 200 comprises: an input unit 210; a memory unit 220; an output unit 230; and a central processing unit (CPU) that includes an arithmetic unit 240 and a control unit 250.

The input unit 210 downloads data inputted from outside of the simulation device. Employed in this input unit 210 are a keyboard, a mouse, and so on.

The memory unit 220 includes a main memory unit and an auxiliary memory unit. Of these, the main memory unit temporarily stores a program or data required in the arithmetic unit 240 and the control unit 250. On the other hand, the auxiliary memory unit supports the main memory unit, and may employ a hard disk, a floppy disk, and so on. In many cases, the likes of a correct structure and a comparative structure of the semiconductor device are stored in the auxiliary memory unit, and during execution of simulation, are downloaded into the main memory unit and then processed by the arithmetic unit 240, and so on.

The output unit 230 outputs data stored in the main memory unit of the memory unit 220, for example, an analysis result of a structural defect of the semiconductor device, and so on, to outside of the simulation device. A display, a printer, and so on, may be employed.

The arithmetic unit 240 processes arithmetic related to data processing. Specifically, during analysis of a structural defect of the semiconductor device, the arithmetic unit 240 reads the correct structure and the comparative structure of the semiconductor device from the main memory unit of the memory unit 220, and returns the analysis result again to the main memory unit.

The control unit 250 controls the input unit 210, the memory unit 220, the output unit 230, and the arithmetic unit 240, in accordance with a program of analysis of a structural defect of the semiconductor device stored in the main memory unit of the memory unit 220.

Next, the arithmetic unit 240 will be described.

FIG. 6 is a functional block diagram of the arithmetic unit of the simulation device of the semiconductor device according to the present embodiment.

The arithmetic unit 240 comprises: a correct structure acquiring unit 241; a structure-to-be-analyzed generating unit 242; and a defect determining unit 243. The correct structure acquiring unit 241 acquires data of the correct structure of the semiconductor device from the main memory unit of the memory unit 220. The correct structure referred to here is a structure of the semiconductor device assuming that each of the wiring lines has been manufactured in a position as designed under a process condition as designed. Note that the correct structure may be generated in the simulation device, or may be generated by another device and inputted to the simulation device. The structure-to-be-analyzed generating unit 242 is inputted with data of the correct structure of the semiconductor device from the correct structure acquiring unit 241 and generates data of a structure-to-be-analyzed. The structure-to-be-analyzed referred to here is a simulated structure of the semiconductor device generated under a certain condition of the process condition, and so on. The defect determining unit 243 acquires data of the structure-to-be-analyzed from the structure-to-be-analyzed generating unit 242, and analyzes a wiring line defect based on this structure-to-be-analyzed. Note that all or part of processing of the correct structure acquiring unit 241, the structure-to-be-analyzed generating unit 242, and the defect determining unit 243 may be processed by a user him-or-herself or by another configuration of the simulation device shown in FIG. 5.

Next, a simulation method for analyzing a structural defect of the semiconductor device will be described.

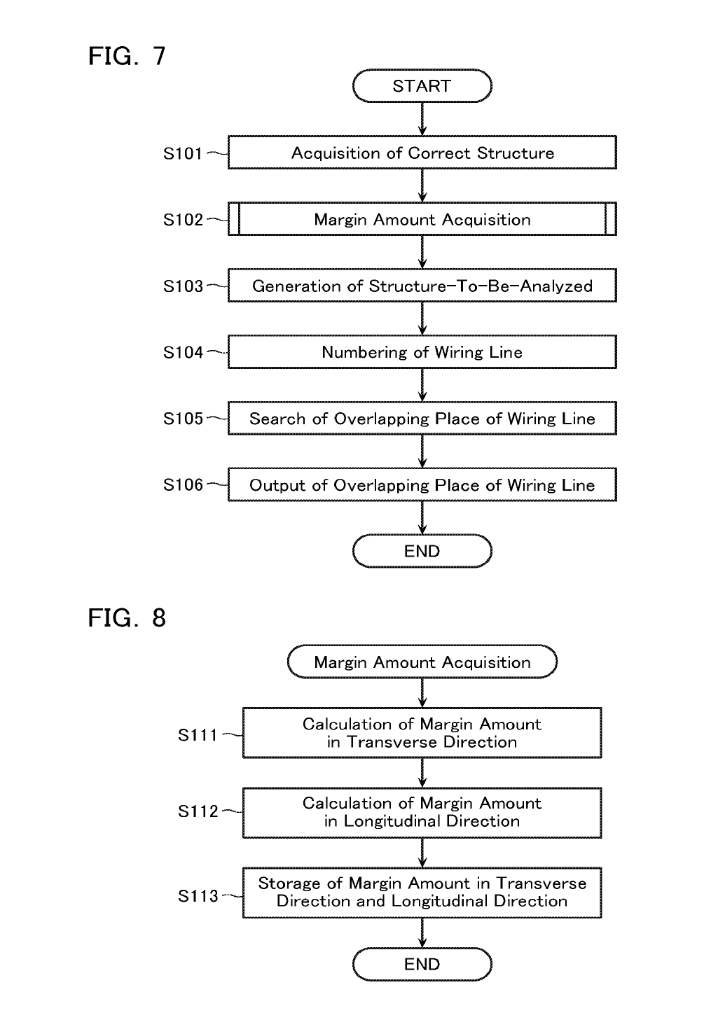

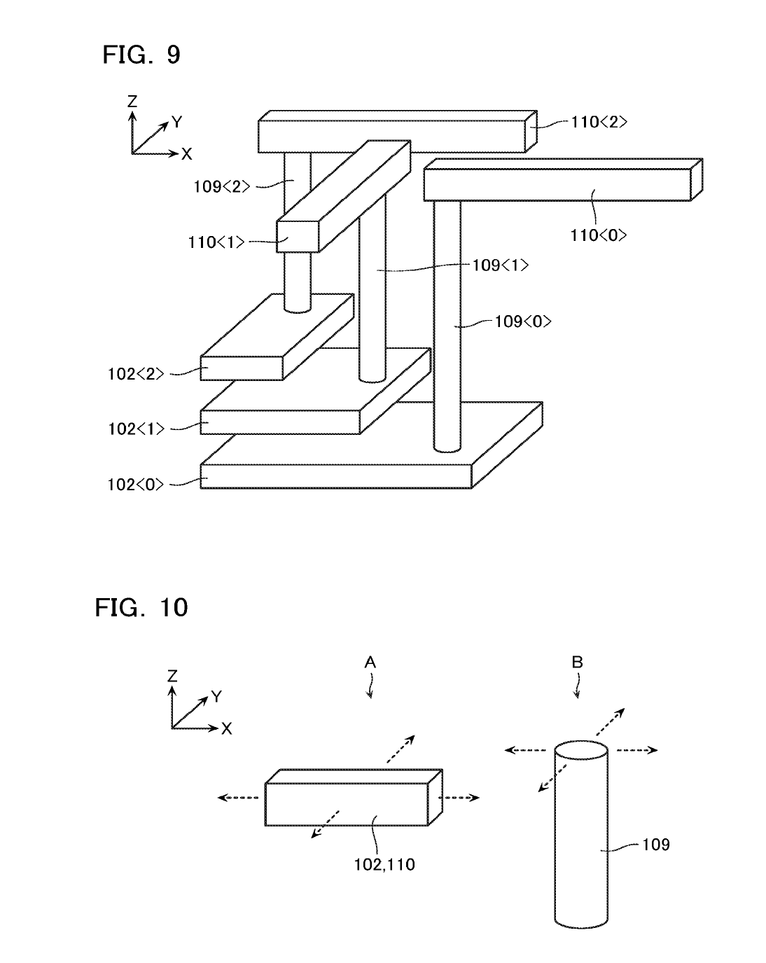

FIGS. 7 and 8 are flowcharts of the simulation method of the semiconductor device according to the present embodiment; and FIGS. 9 to 15 are conceptual views related to the simulation method of the same semiconductor device.

First, in step S101, the correct structure of the semiconductor device is acquired.

Now, an example of the correct structure used in the description below is shown in FIG. 9. The correct structure of FIG. 9 is part of a structure of the contact portion 102b. FIG. 9 shows conductive layers 102<0> to 102<2> stacked from below to above, vias 109<0> to 109<2> connected to the conductive layers 102<0> to 102<2> and extending in the Z direction, and wiring lines 110<0> to 110<2> connected to upper ends of the vias 109<0> to 109<2>. In this step S101, an electrical connection relationship of the conductive layer 102, via 109, and wiring line 110 may be understood.

Then, in step S102, a margin amount of each of the wiring lines is acquired. This step S102 includes steps S111 to S113 indicated below.

First, in step S111, the margin amount in a transverse direction (X direction or Y direction) of each of the wiring lines is calculated. Now, as shown in FIG. 10, the margin amount in the transverse direction of the conductive layer 102 and wiring line 110 (A in FIG. 10) and the margin amount in the transverse direction of the via 109 (B in FIG. 10), are calculated. The margin amount in the transverse direction occurs due to a processing conversion difference related to the likes of variation in lithography related to defocus, roughness, and so on, taper, and shoulder damage of a mask, for example. Moreover, in the case that a sidewall processing process is employed, the margin amount in the transverse direction occurs also due to variation in a spacer film thickness, variation in slimming of a core material, and taper of the core material. In addition, in the case of a three-dimensional wiring line structure as in FIG. 9, the margin amount in the transverse direction occurs also due to variation in slimming of a resist. These generating factors of margin in the transverse direction are each generated independently, hence the margin amount is calculated by a sum of squares of respective variation amounts. Note that when simplifying the simulation, the margin amount in the transverse direction may be a fixed value.

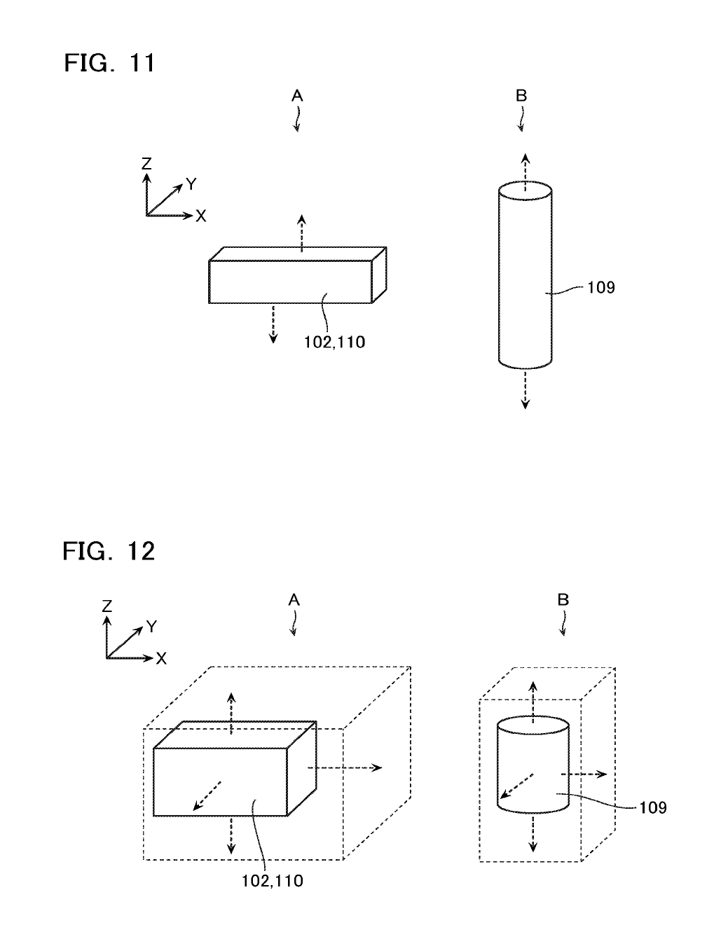

Then, in step S112, the margin amount in a longitudinal direction (Z direction) of each of the wiring lines is calculated. Now, as shown in FIG. 11, the margin amount in the longitudinal direction of the conductive layer 102 and wiring line 110 (A in FIG. 11) and the margin amount in the longitudinal direction of the via 109 (B in FIG. 11), are calculated. The margin amount in the longitudinal direction occurs due to variation in etching, and variation in film thickness of about ±10%, for example. These generating factors of margin in the longitudinal direction are each generated independently, hence the margin amount is calculated by a sum of squares of respective variation amounts. Note that when it is desired to simplify the simulation, the margin amount in the longitudinal direction may be a fixed value.

Finally, in step S113, the margin amounts in the transverse direction and the longitudinal direction calculated insteps S111 and S112 are once stored in the memory unit 220.

That concludes a flow of acquisition of margin amount in step S102. Hereafter, description will be returned to a flow of a main routine.

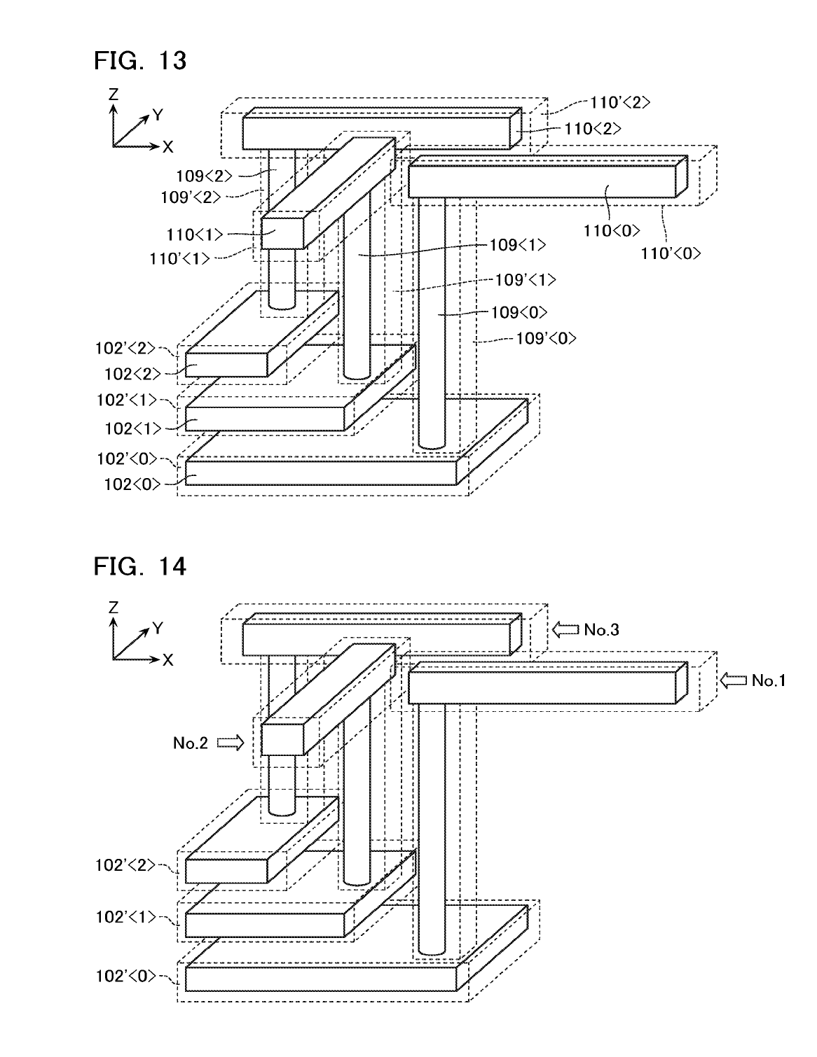

Following acquisition of the margin amount of step S102, in step S103, the structure-to-be-analyzed of the semiconductor device is generated. The structure-to-be-analyzed is a structure having a margin region added to each of the wiring lines of the correct structure. As shown in FIG. 12, the margin region is a region generated in view of the margin amounts of each of the wiring lines calculated in step S102, and is a region indicating a range of assumed variation of the conductive layer 102 and wiring line 110 (broken line of A in FIG. 12) and a range of assumed variation of the via 109 (broken line of B in FIG. 12). Note that the margin region is a rectangular parallelepiped in the case of B in FIG. 12, but may be a cylinder or an elliptic cylinder to match a shape of the via 109. The structure-to-be-analyzed with respect to the correct structure of FIG. 9 is shown by the broken lines of FIG. 13. The conductive layers 102<0> to 102<2>, the vias 109<0> to 109<2>, and the wiring lines 110<0> to 110<2> of the correct structure respectively have the margin region added thereto to become conductive layers 102′<0> to 102′<2>, vias 109′<0> to 109′<2>, and wiring lines 110′<0> to 110′<2>. The generated conductive layers 102′<0> to 102′<2>, vias 109′<0> to 109′<2>, and wiring lines 110′<0> to 110′<2> of course have a structure of the conductive layers 102<0> to 102<2>, vias 109<0> to 109<2>, and wiring lines 110<0> to 110<2> thickened to an extent of the margin amount.

Next, in step S104, numbering of the wiring lines of the structure-to-be-analyzed of the semiconductor device is performed. All of the wiring lines that are electrically connected in the correct structure are assigned with one number. In other words, fellow wiring lines that are electrically unconnected in the correct structure are assigned with different numbers. Numbering of the structure-to-be-analyzed of FIG. 13 is shown in FIG. 14. In the case of FIG. 14, the conductive layer 102′<0> and the wiring line electrically connected thereto are assigned with “No. 1”, the conductive layer 102′<1> and the wiring line electrically connected thereto are assigned with “No. 2”, and the conductive layer 102′<2> and the wiring line electrically connected thereto are assigned with “No. 3”. Note that this step S104 has an object of distinguishing fellow wiring lines that are electrically unconnected, hence application of different colors, assignment of specific names, and so on, are possible instead of numbering of the wiring lines.

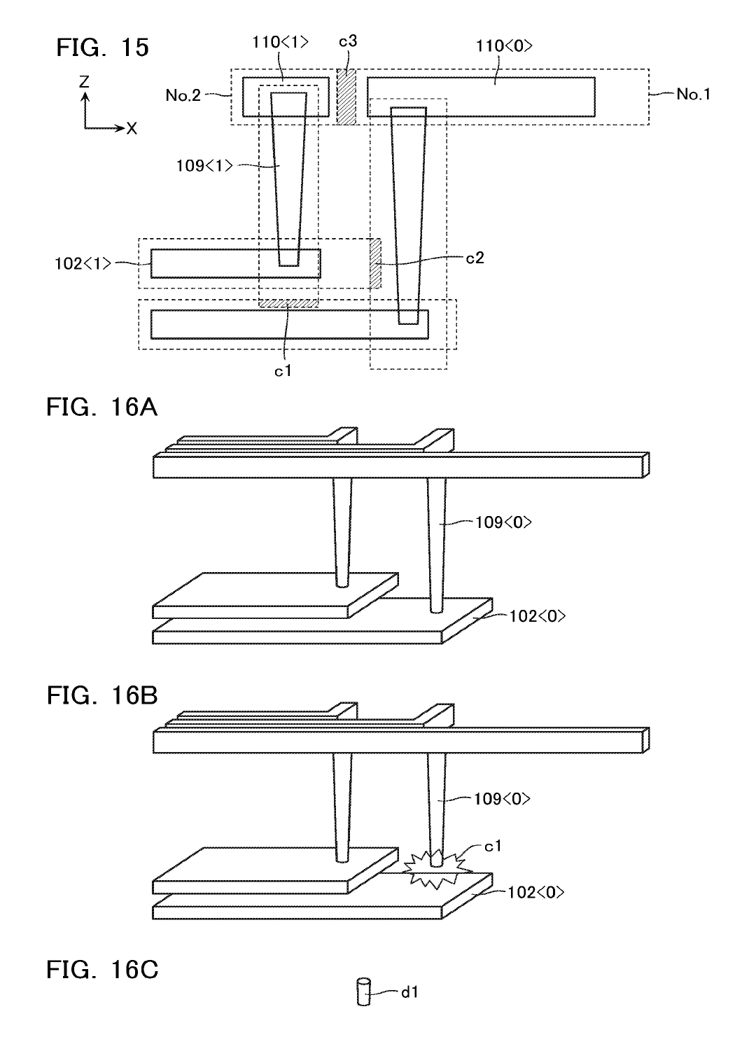

Next, in step S105, an overlapping place between wiring lines having different numbers of the structure-to-be-analyzed, is searched for. The fact that there is an overlapping place between wiring lines having different numbers means that fellow wiring lines that are originally electrically unconnected are shorting, that is, short-circuiting, and means that if the semiconductor device was actually manufactured under the same process condition as the simulation, there is a high risk of a wiring line defect occurring in a range of assumable variation of the wiring line structure. In the case of the structure-to-be-analyzed of FIG. 13, it is found that three overlapping places, in other words, risk places c1 to c3 shown by slanting lines in FIG. 15 exist between the wiring line of “No. 1” and the wiring line of “No. 2”.

Finally, in step S106, the overlapping place between wiring lines having different numbers of the structure-to-be-analyzed is outputted to the memory unit 220 as an analysis result. This analysis result is outputted to the output unit 230 such as a display, for example, and is reported to the user. The user can know a cause of generation of each risk place from this analysis result. For example, the risk place c1 is conceivably due to over-etching when forming the via 109<1>. The risk place c2 is conceivably due to variation in slimming when forming the conductive layer 102<1>. The risk place c3 is conceivably due to variation in lithography before forming the wiring lines 110<0> and 110<1>.

That concludes a flow of the simulation method of the semiconductor device according to the present embodiment.

Using the simulation device and the simulation method according to the present embodiment makes it possible to mechanically extract a risk place of a wiring line defect, including also a position of the wiring line defect, of a semiconductor device having a complicated three-dimensional wiring line structure. In other words, the present embodiment makes it possible to achieve a shortening of development period and reduction in development cost of the semiconductor device.

### Second Embodiment

The first embodiment described a simulation device and simulation method for performing analysis of a wiring line defect. However, in these device and method, although a short defect, that is, a short-circuit defect can be analyzed, an open defect, that is, an open-circuit defect cannot be analyzed. Accordingly, a second embodiment will describe a simulation device and simulation method capable of analysis of not only a short defect but also an open defect of a wiring line structure. Here, differences from the first embodiment will mainly be described.

First, a summary of a simulation method of a semiconductor device according to the second embodiment will be described.

FIGS. 16A to 16C are conceptual views of the simulation method of the semiconductor device according to the present embodiment.

In the present embodiment, the correct structure of the semiconductor device, the comparative structure of the semiconductor device, and a difference between these correct structure and comparative structure are employed to perform analysis of an open defect and a short defect. Considered as a specific example will be the case where, with respect to the correct structure of the semiconductor device shown in FIG. 16A, there exists the comparative structure of the semiconductor device shown in FIG. 16B. In the correct structure, the conductive layer 102<0> and the via 109<0> are connected, whereas in the comparative structure, the conductive layer 102<0> and the via 109′<0> are not connected. This is caused by a lower end of the via 109′<0> not reaching the conductive layer 102<0> (c1 in FIG. 16B), and as shown in FIG. 16C, this appears as a difference d1 of the correct structure and the comparative structure. The present embodiment utilizes this difference of the correct structure and the comparative structure to mechanically detect a defect of a complex three-dimensionally disposed wiring line structure.

Next, a simulation device of the present embodiment will be described.

The simulation device of the present embodiment has the configuration shown in FIG. 5, and has a configuration of an arithmetic unit 340 which is different compared to the simulation device of the first embodiment.

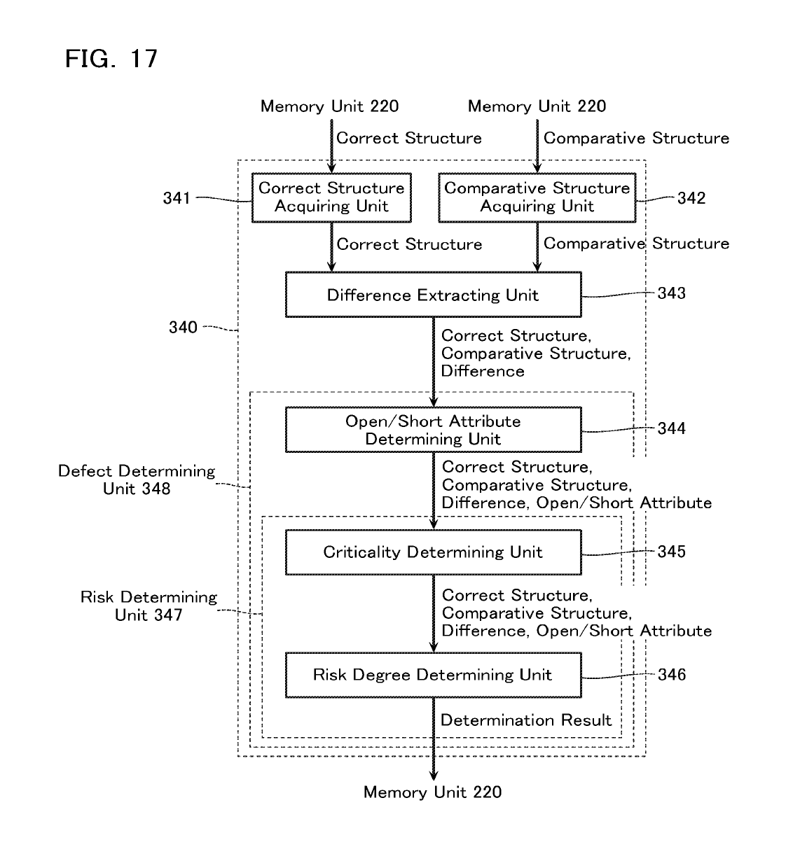

FIG. 17 is a functional block diagram of the arithmetic unit of the simulation device of the semiconductor device according to the present embodiment.

The arithmetic unit 340 comprises: a correct structure acquiring unit 341; a comparative structure acquiring unit 342; a difference extracting unit 343; an open/short attribute determining unit 344; a criticality determining unit 345; and a risk degree determining unit 346. Of these, the criticality determining unit 345 and the risk degree determining unit 346 are included in a risk determining unit 347. Moreover, the open/short attribute determining unit 344 and the risk determining unit 347 are included in a defect determining unit 348.

The correct structure acquiring unit 341 acquires data of the correct structure of the semiconductor device from the main memory unit of the memory unit 220. The correct structure referred to here is a structure of the semiconductor device assuming that each of the wiring lines has been manufactured in a position as designed under a process condition as designed. The comparative structure acquiring unit 342 acquires data of the comparative structure of the semiconductor device from the main memory unit of the memory unit 220. The comparative structure referred to here is a simulated structure of the semiconductor device generated under a certain condition of the process condition, and so on. The difference extracting unit 343 is inputted with data of the correct structure and the comparative structure from the correct structure acquiring unit 341 and the comparative structure acquiring unit 342, and extracts the difference of these correct structure and comparative structure. Moreover, as required, the difference extracting unit 343 divides the difference on the basis of closed regions, and further divides those into being inside/outside the correct structure. Hereafter, a divided difference will sometimes also be referred to as a “partial difference”, as required. Moreover, when simply referred to as “difference”, the difference before/after division is assumed to be included. The open/short attribute determining unit 344 is inputted with data of the correct structure, the comparative structure, and the difference from the difference extracting unit 343, and determines for each difference whether it is an open attribute creating a risk of an open defect or is a short attribute creating a risk of a short defect. The criticality determining unit 345 is inputted with data of the correct structure, the comparative structure, the difference, and the open/short attribute from the open/short attribute determining unit 344, and determines for each difference whether it creates an open defect or a short defect. The risk degree determining unit 346 is inputted with data of the correct structure, the comparative structure, the difference, and the open/short attribute from the criticality determining unit 345, determines for each difference a risk degree (risk) of an open defect or a short detect, and outputs a determination result. Note that processing in the risk degree determining unit 346 is executed targeting a difference that will be a critical open defect or short defect. Note that all or part of processing of the correct structure acquiring unit 341, the comparative structure acquiring unit 342, the difference extracting unit 343, and the defect determining unit 348 may be processed by the user him-or-herself or by another configuration of the simulation device shown in FIG. 5.

Next, the simulation method for analyzing a structural defect of the semiconductor device will be described.

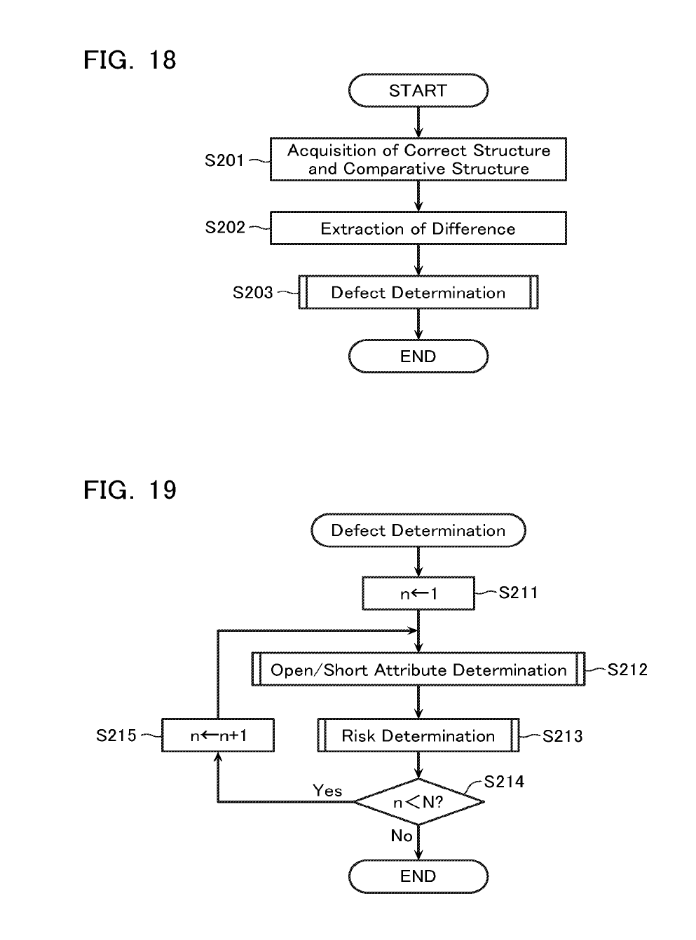

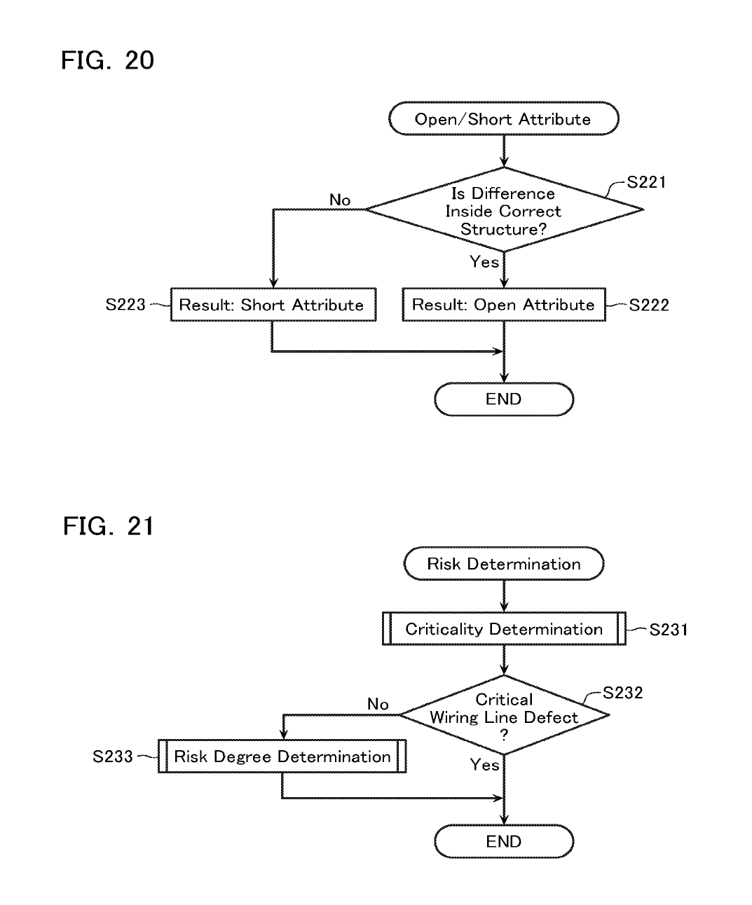

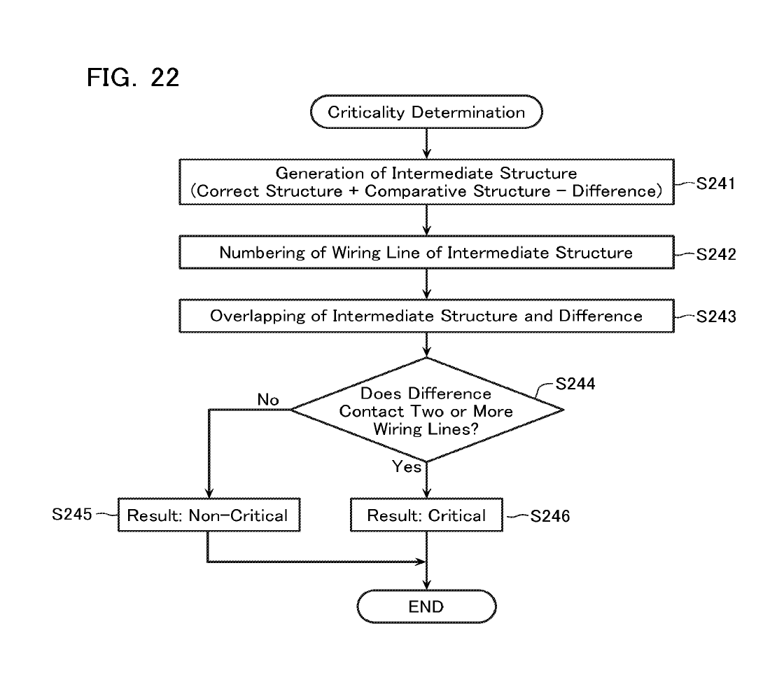

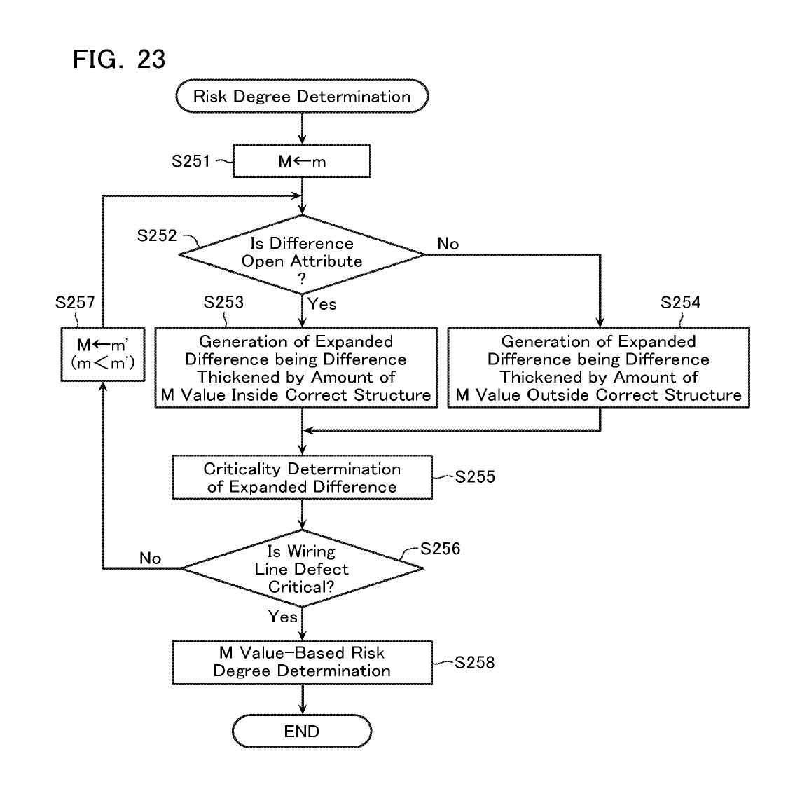

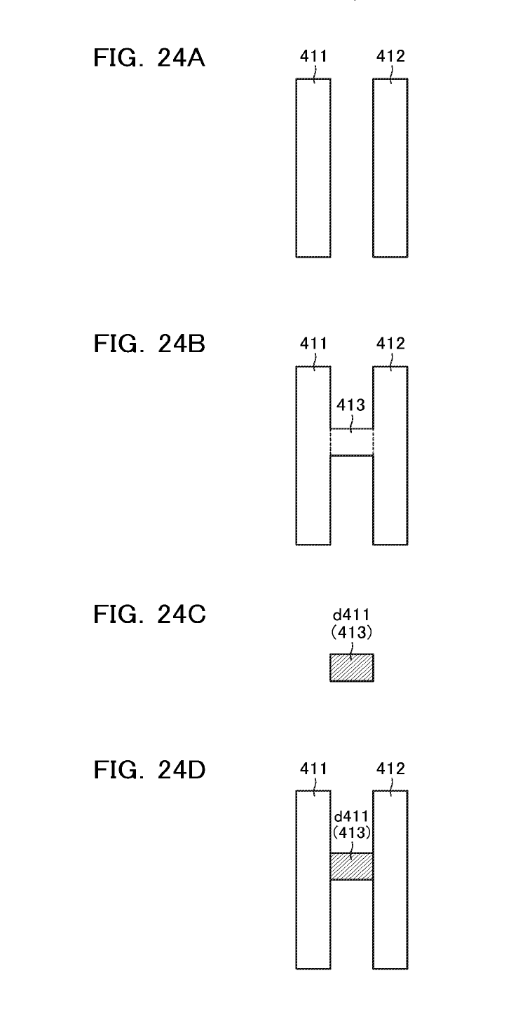

FIGS. 18 to 23 are flowcharts of the simulation method of the semiconductor device according to the present embodiment; and FIGS. 24 to 35 are specific examples related to the simulation method of the same semiconductor device. In order to facilitate understanding of the simulation method of the present embodiment, in FIGS. 24 to 35, the three-dimensionally disposed wiring line structure is expressed two-dimensionally.

First, in step S201, the correct structure and the comparative structure of the semiconductor device are acquired. Moreover, coordinate data of the correct structure and the comparative structure is also acquired. Then, in step S202, the difference between the correct structure and the comparative structure of the semiconductor device is extracted to be divided into partial differences. Moreover, coordinate data of each partial difference is acquired. As a result, specification of an occurrence place of a wiring line defect is enabled.

Then, in step S203, defect determination is executed for each difference. This step S203 includes steps S211 and S212 indicated below.

First, in step S211, a number n for managing each difference is initialized to 1.

Then, in step S212, the open/short attribute of the n-th difference is determined. This step S212 includes steps S221 to S223 indicated below.

First, in step S221, it is determined whether the difference is inside the correct structure. This determination is executed based on the coordinate data of the correct structure and the difference. If the difference is inside the correct structure, then a determination to the effect that the difference has an open attribute is made in step S222, and if the difference is outside the correct structure, then a determination to the effect that the difference has a short attribute is made in step S223.

That concludes a flow of open/short attribute determination of step S212.

Now, determination of the open/short attribute will be described using several specific examples.

FIGS. 24A to 24D are an example of the case where the difference has a short attribute.

As shown in FIG. 24A, the correct structure of the semiconductor device includes two wiring lines 411 and 412 extending in parallel. As shown in FIG. 24B, the comparative structure of the semiconductor device, in contrast to the correct structure, includes a conductive portion 413 shorting the wiring lines 411 and 412. In this case, as shown in FIG. 24C, the conductive portion 413 is extracted as a difference d411. Moreover, as shown in FIG. 24D, the difference d411 is outside the correct structure, hence a determination to the effect that the difference d411 has a short attribute is made.

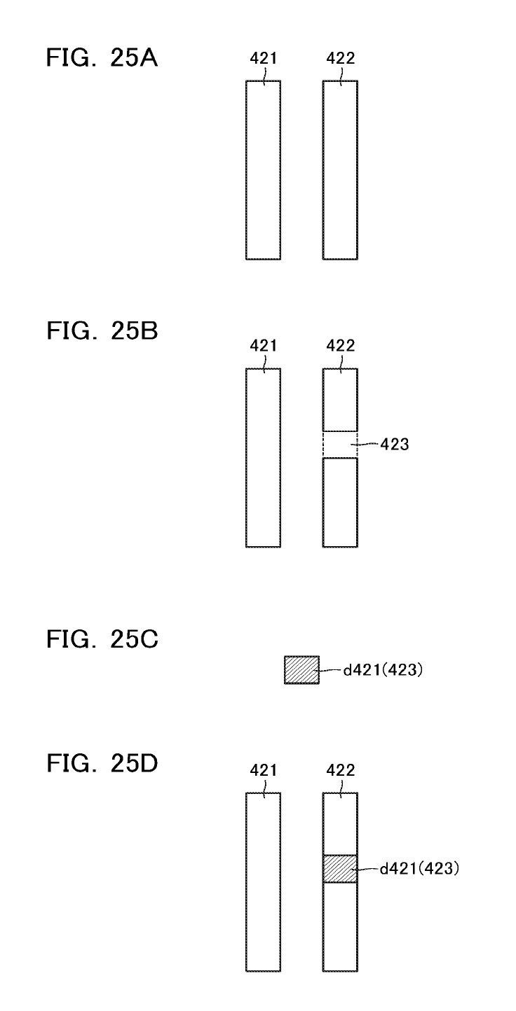

FIGS. 25A to 25D are an example of the case where the difference has an open attribute.

As shown in FIG. 25A, the correct structure of the semiconductor device includes two wiring lines 421 and 422 extending in parallel. As shown in FIG. 25B, the comparative structure of the semiconductor device, in contrast to the correct structure, includes a gap portion 423 opening one wiring line 422. In this case, as shown in FIG. 25C, the gap portion 423 is extracted as a difference d421. Moreover, as shown in FIG. 25D, the difference d421 is inside the wiring line 422 of the correct structure, hence a determination to the effect that the difference d421 has an open attribute is made.

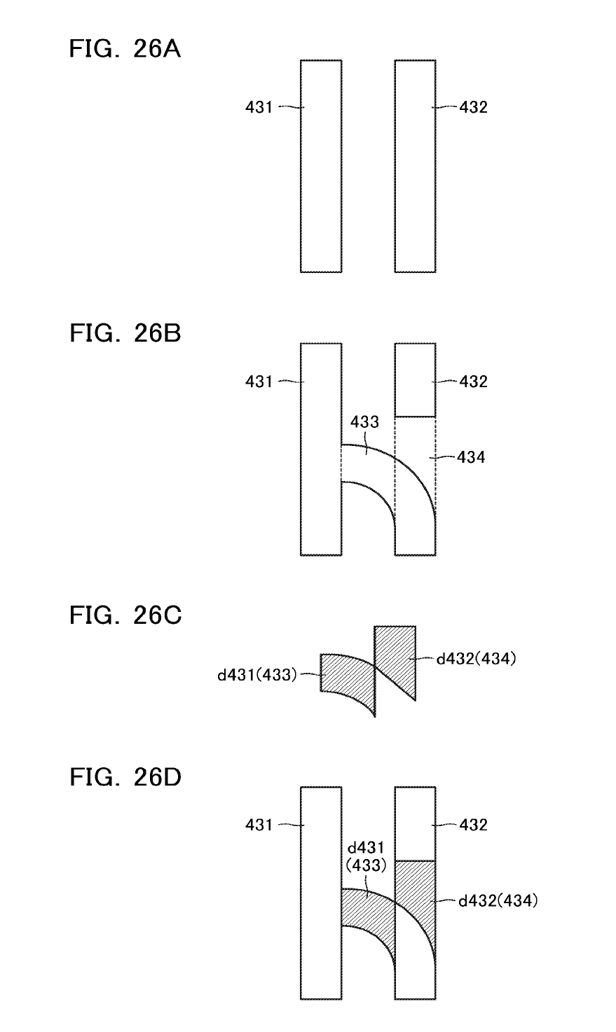

FIGS. 26A to 26D are an example of the case where a certain difference has an open attribute and another difference has a short attribute.

As shown in FIG. 26A, the correct structure of the semiconductor device includes two wiring lines 431 and 432 extending in parallel. As shown in FIG. 26B, the comparative structure of the semiconductor device, in contrast to the correct structure, includes a conductive portion 433 shorting the wiring lines 431 and 432, and a gap portion 434 opening one wiring line 432. In this case, as shown in FIG. 26C, the conductive portion 433 is extracted as a difference d431, and the gap portion 434 is extracted as a difference d432. Moreover, as shown in FIG. 26D, the difference d431 is outside the correct structure, hence a determination to the effect that the difference d431 has a short attribute is made. On the other hand, the difference d432 is inside the wiring line 432 of the correct structure, hence a determination to the effect that the difference d432 has an open attribute is made.

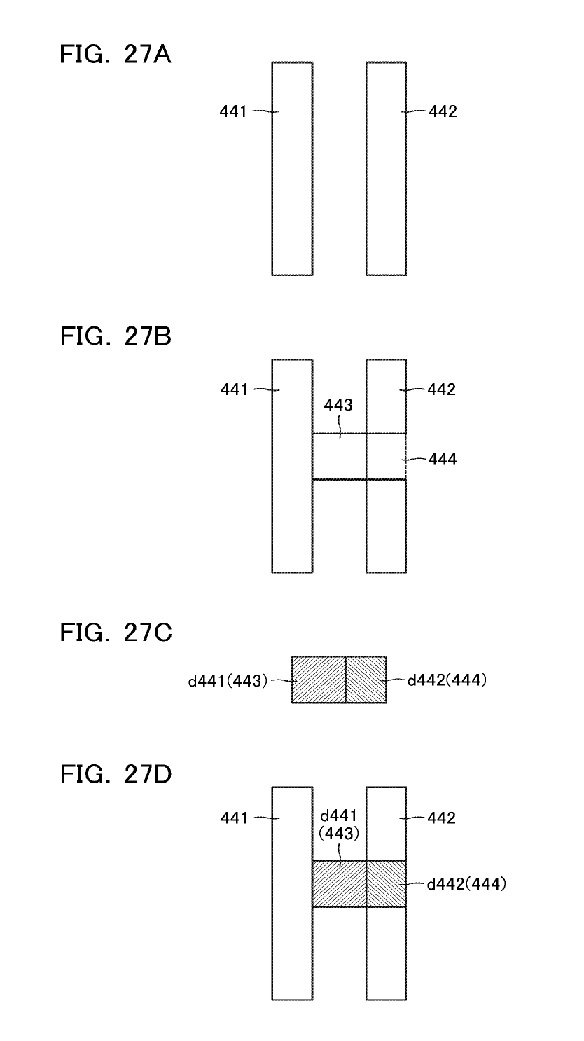

FIGS. 27A to 27D are an example of the case where a certain difference has an open attribute and another difference has a short attribute.

As shown in FIG. 27A, the correct structure of the semiconductor device includes two wiring lines 441 and 442 extending in parallel. As shown in FIG. 27B, the comparative structure of the semiconductor device, in contrast to the correct structure, includes a conductive portion 443 shorting the wiring lines 441 and 442, and a gap portion 444 opening one wiring line 442. In this case, as shown in FIG. 27C, the conductive portion 443 is extracted as a difference d441, and the gap portion 444 is extracted as a difference d442. Moreover, as shown in FIG. 27D, the difference d441 is outside the correct structure, hence a determination to the effect that the difference d441 has a short attribute is made. On the other hand, the difference d442 is inside the wiring line 442 of the correct structure, hence a determination to the effect that the difference d442 has an open attribute is made.

That concludes the specific examples of open/short attribute determination. Hereafter, description will be returned to a flow of defect determination.

Following the open/short attribute determination of step S212, in step S213, risk determination is executed for each difference. This step S213 includes steps S231 to S233 indicated below.

First, in step S231, criticality determination is executed for each difference. This step S231 includes steps S241 to S246 indicated below.

First, in step S241, an intermediate structure of the semiconductor device is generated. The intermediate structure is a difference set having the difference subtracted from a sum-set of the correct structure and the comparative structure.

Then, in step S242, numbering of the wiring lines of the intermediate structure of the semiconductor device is performed. All of the wiring lines that are electrically connected in the intermediate structure are assigned with one number. Note that this step S242 has an object of distinguishing fellow wiring lines that are electrically unconnected, hence application of different colors, assignment of specific names, and soon, are possible instead of numbering of the wiring lines.

Then, in step S243, the intermediate structure of the semiconductor device and the difference are overlapped.

Then, in step S244, it is determined whether as a result of the overlapping performed in step S243, the difference is not contacting two or more wiring lines having different numbers. If the difference is not contacting two or more wiring lines having different numbers, then a determination to the effect that the difference is not a critical wiring line defect is made in step S245, and if the difference is contacting two or more wiring lines having different numbers, then a determination to the effect that the difference is a critical wiring line defect is made in step S246.

That concludes a flow of criticality determination of step S231.

Now, criticality determination will be described using several specific examples.

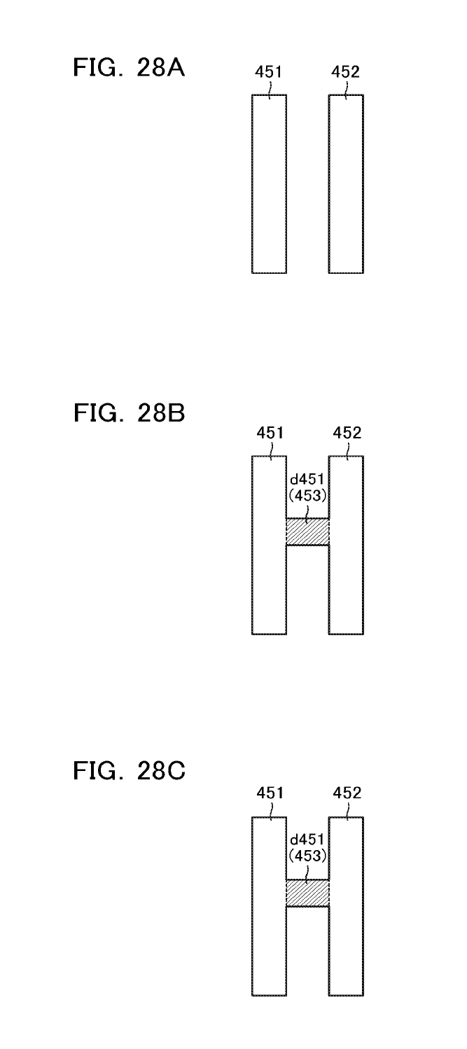

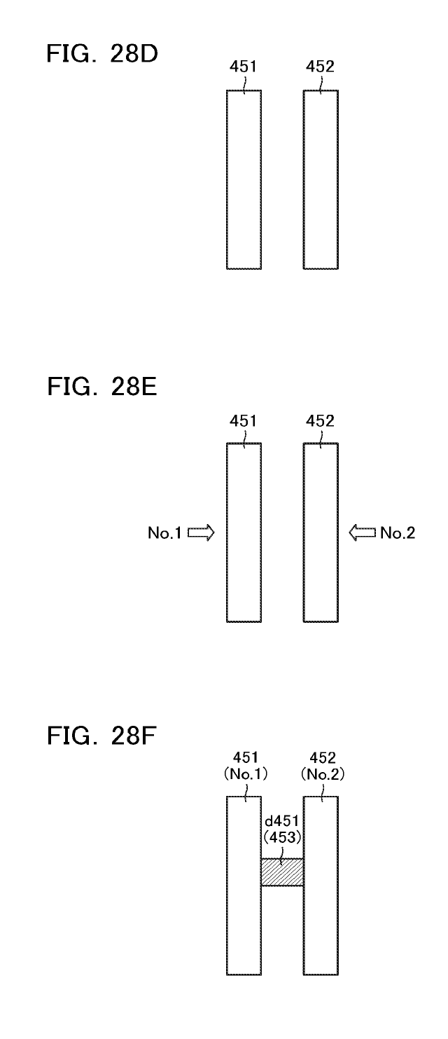

FIGS. 28A to 28F are an example of the case where the difference has a short attribute.

As shown in FIG. 28A, the correct structure of the semiconductor device includes two wiring lines 451 and 452 extending in parallel. As shown in FIG. 28B, the comparative structure of the semiconductor device, in contrast to the correct structure, includes a conductive portion 453 shorting the wiring lines 451 and 452. This conductive portion 453 is extracted as a difference d451. As a result, in this case, the sum-set of the correct structure and the comparative structure is a structure configured from the wiring lines 451 to 453 as shown in FIG. 28C, and the intermediate structure includes the wiring lines 451 and 452 as shown in FIG. 28D. Now, as shown in FIG. 28E, the wiring line 451 is assigned with “No. 1”, and the wiring line 452 electrically unconnected to the wiring line 451 is assigned with “No. 2” different from “No. 1”. Finally, it is found that as shown in FIG. 28F, when the difference d451 is overlapped on the intermediate structure, the difference d451 contacts the wiring line 451 of “No. 1” and the wiring line 452 of “No. 2”. As a result, a determination to the effect that the difference d451 is a critical wiring line defect is made.

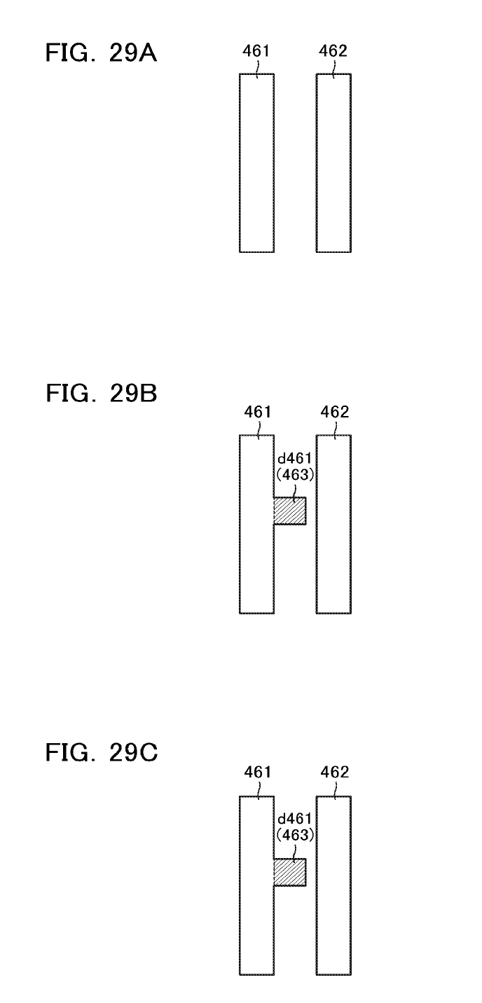

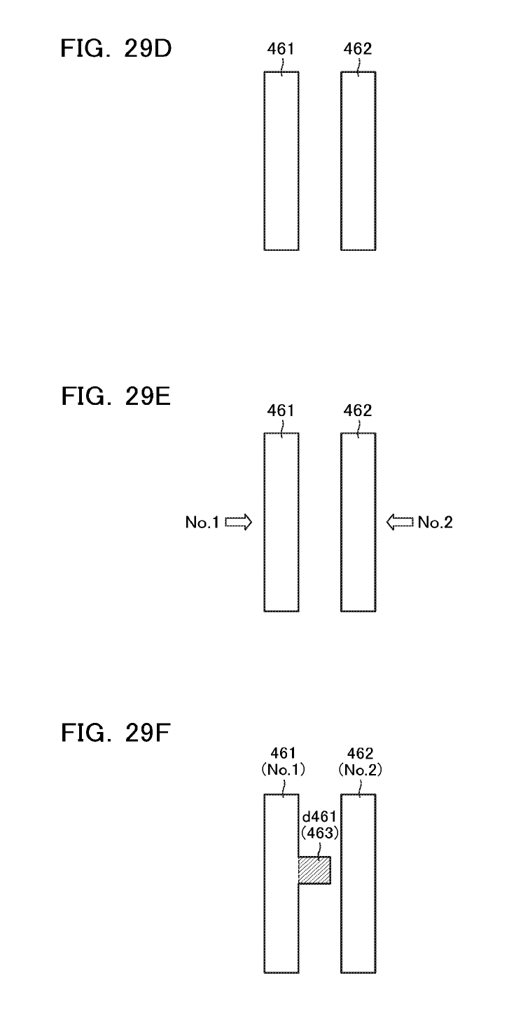

FIGS. 29A to 29F are an example of the case where the difference has a short attribute.

As shown in FIG. 29A, the correct structure of the semiconductor device includes two wiring lines 461 and 462 extending in parallel. As shown in FIG. 29D, the comparative structure of the semiconductor device, in contrast to the correct structure, includes a conductive portion 463 connected only to the wiring line 461. This conductive portion 463 is extracted as a difference d461. As a result, in this case, the sum-set of the correct structure and the comparative structure is a structure configured from the wiring lines 461 to 463 as shown in FIG. 29C, and the intermediate structure includes the wiring lines 461 and 462 as shown in FIG. 29D. Now, as shown in FIG. 29E, the wiring line 461 is assigned with “No. 1”, and the wiring line 462 electrically unconnected to the wiring line 461 is assigned with “No. 2” different from “No. 1”. Finally, it is found that as shown in FIG. 29F, when the difference d461 is overlapped on the intermediate structure, the difference d461 contacts only the wiring line 461 of “No. 1”. As a result, a determination to the effect that the difference d461 is a non-critical wiring line defect is made.

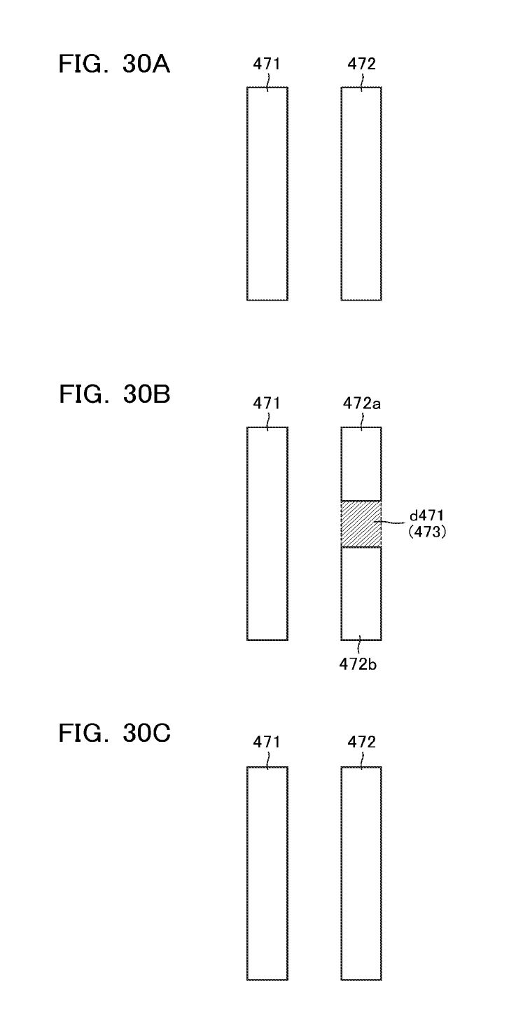

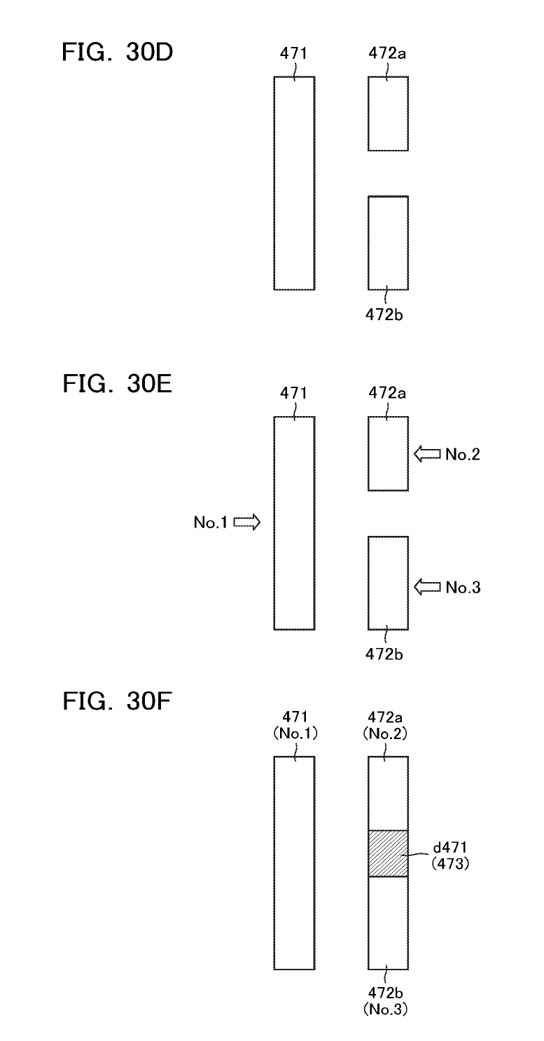

FIGS. 30A to 30F are an example of the case where the difference has an open attribute.

As shown in FIG. 30A, the correct structure of the semiconductor device includes two wiring lines 471 and 472 extending in parallel. As shown in FIG. 30B, the comparative structure of the semiconductor device, in contrast to the correct structure, includes a gap portion 473 opening one wiring line 472. This gap portion 473 is extracted as a difference d471. Hereafter, the two portions of the wiring line 472 divided by the gap portion 473 are assumed to be wiring lines 472a and 472b. As a result, in this case, the sum-set of the correct structure and the comparative structure is a structure configured from the wiring lines 471 and 472 as shown in FIG. 30C, and the intermediate structure includes the wiring lines 471, 472a, and 472b as shown in FIG. 30D. Now, as shown in FIG. 30E, the wiring line 471 is assigned with “No. 1”, the wiring line 472a electrically unconnected to the wiring line 471 is assigned with “No. 2”, and the wiring line 472b electrically unconnected to the wiring lines 471 and 472a is assigned with “No. 3”. Finally, it is found that as shown in FIG. 30F, when the difference d471 is overlapped on the intermediate structure, the difference d471 contacts the wiring line 472a of “No. 2” and the wiring line 472b of “No. 3”. As a result, a determination to the effect that the difference d471 is a critical wiring line defect is made.

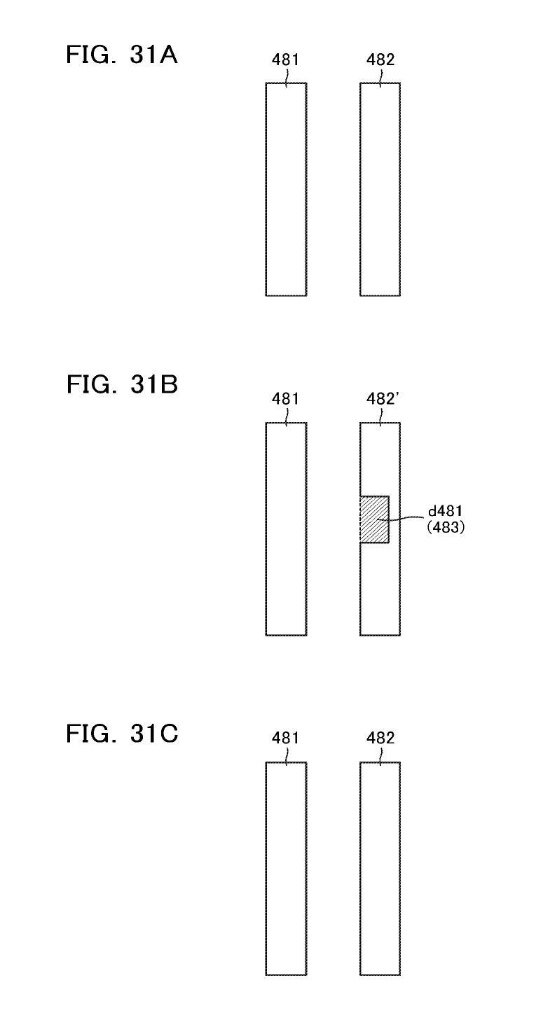

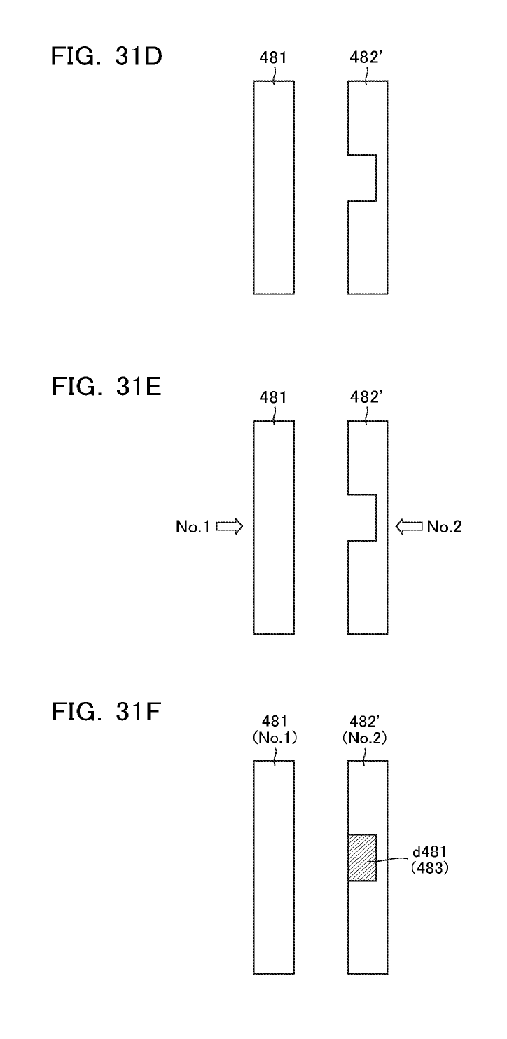

FIGS. 31A to 31F are an example of the case where the difference has an open attribute.

As shown in FIG. 31A, the correct structure of the semiconductor device includes two wiring lines 481 and 482 extending in parallel. As shown in FIG. 31B, the comparative structure of the semiconductor device, in contrast to the correct structure, includes a gap portion 483 gouging out part of the wiring line 482. This gap portion 483 is extracted as a difference d481. Hereafter, the wiring line 482 gouged out by the gap portion 483 is assumed to be a wiring line 482′. As a result, in this case, the sum-set of the correct structure and the comparative structure is a structure configured from the wiring lines 481 and 482 as shown in FIG. 31C, and the intermediate structure includes the wiring lines 481 and 482′ as shown in FIG. 31D. Now, as shown in FIG. 31E, the wiring line 481 is assigned with “No. 1”, and the wiring line 482′ electrically unconnected to the wiring line 481 is assigned with “No. 2” different from “No. 1”. Finally, it is found that as shown in FIG. 31F, when the difference d481 is overlapped on the intermediate structure, the difference d481 contacts only the wiring line 482′ of “No. 2”. As a result, a determination to the effect that the difference d481 is a non-critical wiring line defect is made.

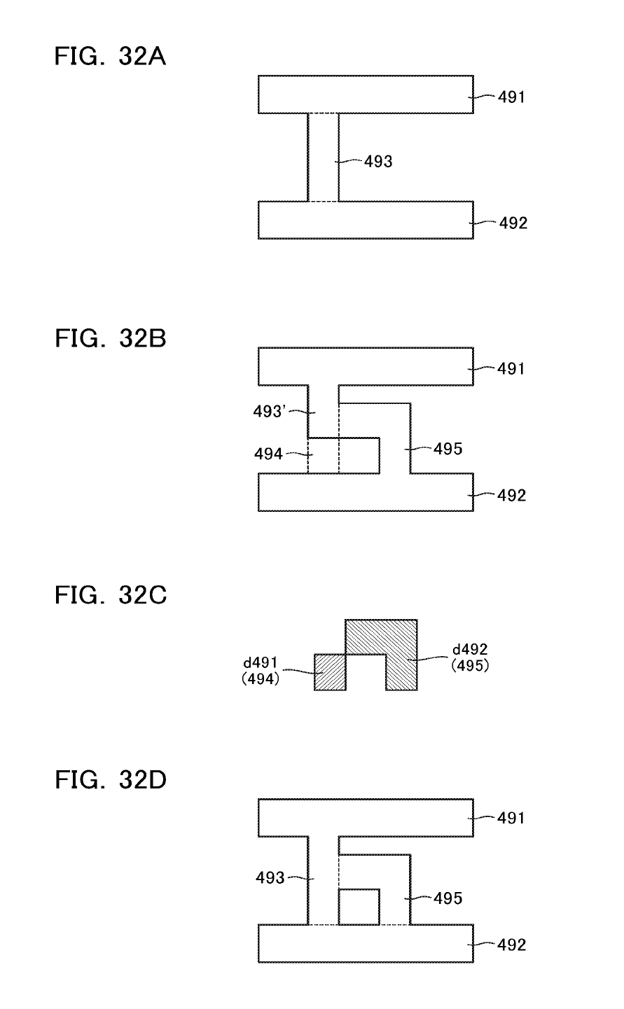

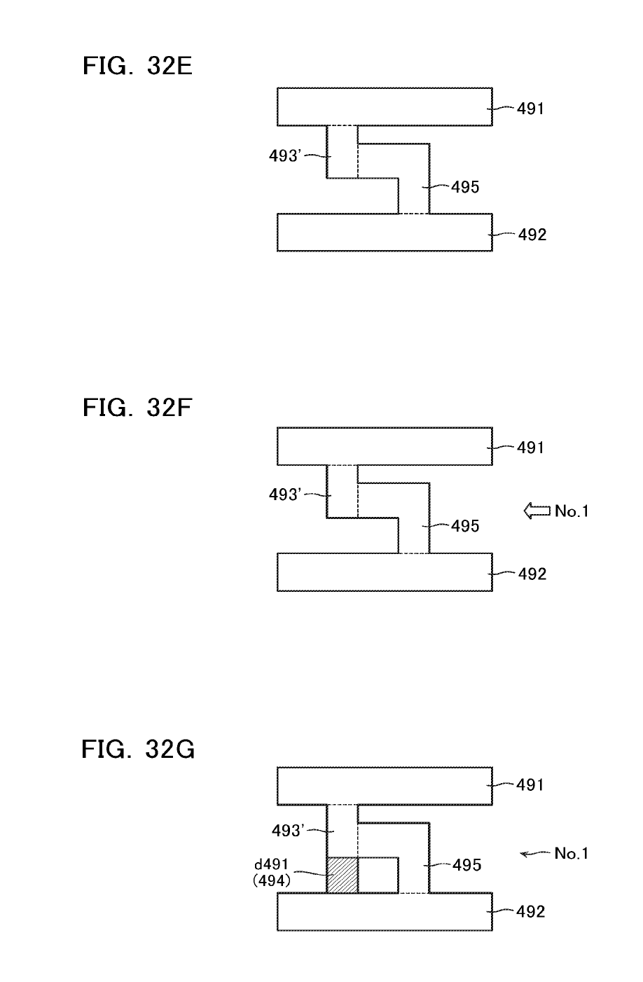

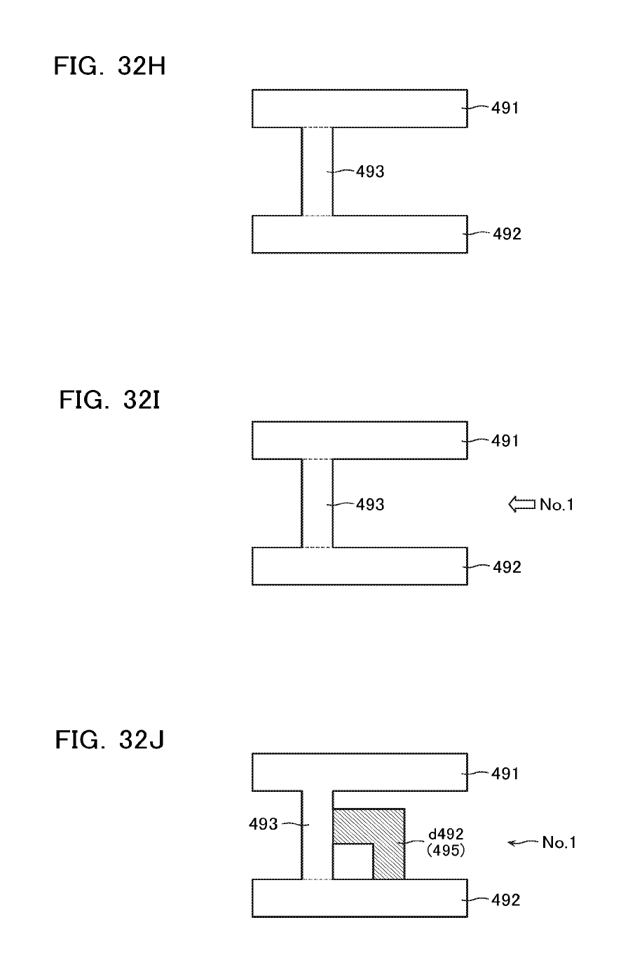

FIGS. 32A to 32J are an example of the case where a certain difference has an open attribute and another difference has a short attribute.

As shown in FIG. 32A, the correct structure of the semiconductor device includes: two wiring lines 491 and 492 extending in parallel; and a wiring line 493 electrically connecting these wiring lines 491 and 492. As shown in FIG. 32B, the comparative structure of the semiconductor device, in contrast to the correct structure, includes: a gap portion 494 opening a wiring line 492 side of the wiring line 493; and a conductive portion 495 shorting the wiring line 492 and the wiring line 493 that has the gap portion 494 formed therein. Hereafter, the wiring line 493 having the gap portion 494 formed therein is assumed to be a wiring line 493′. In this case, as shown in FIG. 32C, the gap portion 494 is extracted as a difference d491, and the conductive portion 495 is extracted as a difference d492. Moreover, as a result, as shown in FIG. 32D, the sum-set of the correct structure and the comparative structure is a structure configured from the wiring lines 491 to 493, and 495.

Now, focusing on the difference d491, as shown in FIG. 32E, the intermediate structure includes the wiring lines 491, 492, 493′, and 495. Now, as shown in FIG. 32F, the electrically connected wiring lines 491, 492, 493′, and 495 are assigned with “No. 1”. Finally, it is found that as shown in FIG. 32G, when the difference d491 is overlapped on the intermediate structure, the difference d491 contacts only the wiring lines 492 and 493′ of “No. 1”. As a result, a determination to the effect that the difference d491 is a non-critical wiring line defect is made.

On the other hand, focusing on the difference d492, as shown in FIG. 32H, the intermediate structure includes the wiring lines 491 to 493. Now, as shown in FIG. 32I, the electrically connected wiring lines 491 to 493 are assigned with “No. 1”. Finally, it is found that as shown in FIG. 32J, when the difference d492 is overlapped on the intermediate structure, the difference d492 contacts only the wiring lines 492 and 493 of “No. 1”. As a result, a determination to the effect that the difference d492 is anon-critical wiring line defect is made.

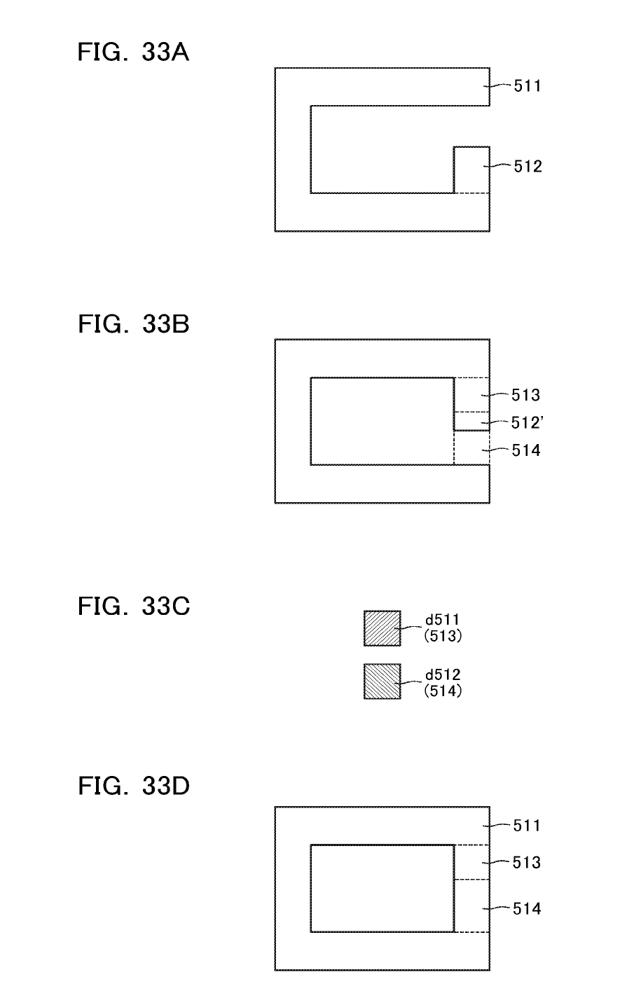

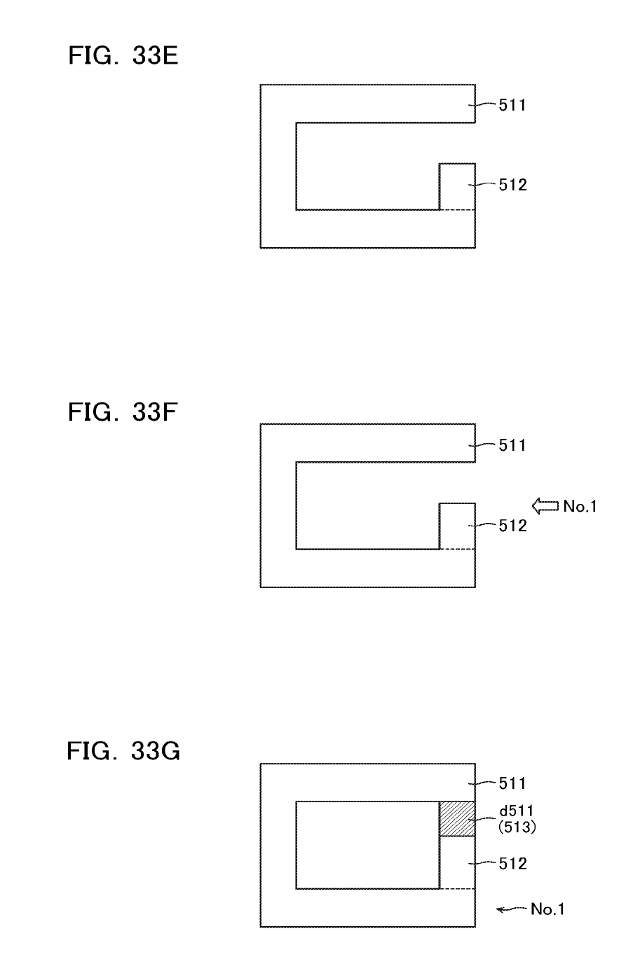

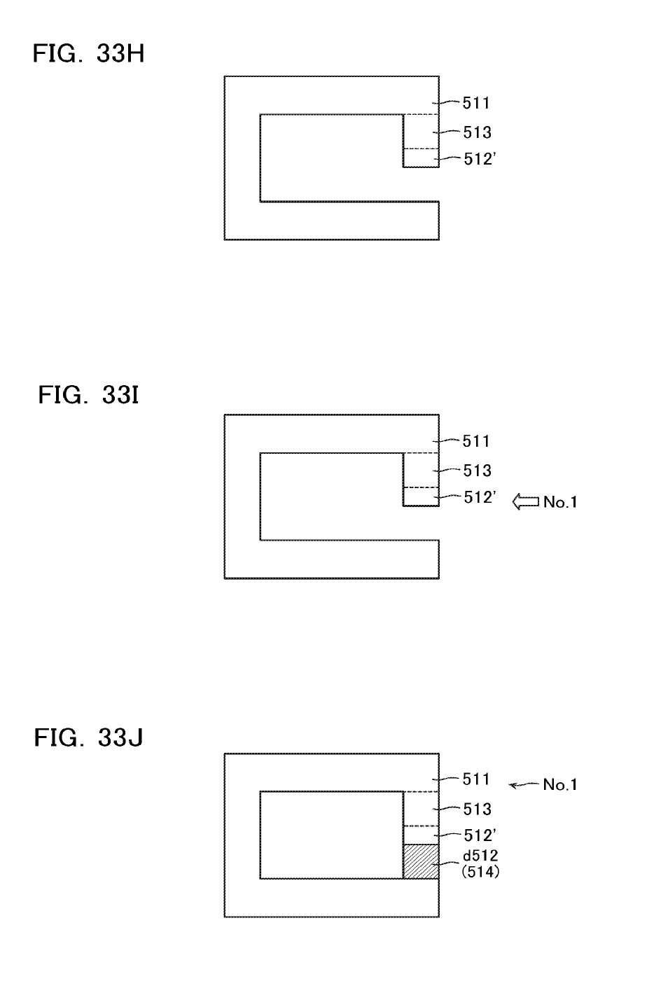

FIGS. 33A to 33J are an example of the case where a certain difference has an open attribute and another difference has a short attribute.

As shown in FIG. 33A, the correct structure of the semiconductor device includes: a C-shaped wiring line 511; and a wiring line 512 connected only to a lower side of an opening of the wiring line 511. As shown in FIG. 33B, the comparative structure of the semiconductor device, in contrast to the correct structure, includes: a conductive portion 513 shorting an upper side of the opening of the wiring line 511 and the wiring line 512; and a gap portion 514 opening a wiring line 511 side of the wiring line 512. Hereafter, the wiring line 512 having the gap portion 514 formed therein is assumed to be a wiring line 512′. In this case, as shown in FIG. 33C, the conductive portion 513 is extracted as a difference d511, and the gap portion 514 is extracted as a difference d512. Moreover, as a result, as shown in FIG. 33D, the sum-set of the correct structure and the comparative structure is a structure configured from the wiring lines 511, 513, and 514.

Now, focusing on the difference d511, as shown in FIG. 33E, the intermediate structure includes the wiring lines 511 and 512. Now, as shown in FIG. 33F, the electrically connected wiring lines 511 and 512 are assigned with “No. 1”. Finally, it is found that as shown in FIG. 33G, when the difference d511 is overlapped on the intermediate structure, the difference d511 contacts only the upper side of the opening of the wiring line 511, and the wiring line 512, of “No. 1”. As a result, a determination to the effect that the difference d511 is a non-critical wiring line defect is made.

On the other hand, focusing on the difference d512, as shown in FIG. 33H, the intermediate structure includes the wiring lines 511, 512′, and 513. Now, as shown in FIG. 33I, the electrically connected wiring lines 511, 512′, and 513 are assigned with “No. 1”. Finally, it is found that as shown in FIG. 33J, when the difference d512 is overlapped on the intermediate structure, the difference d512 contacts only the lower side of the opening of the wiring line 511, and the wiring line 512′, of “No. 1”. As a result, a determination to the effect that the difference d512 is a non-critical wiring line defect is made.

Note that as described above, the comparative structures of the semiconductor device shown in FIGS. 32 and 33, although having no problem electrically, may be determined as having a structural defect when the partial difference contacts two structurally different wiring lines, as required.

That concludes the specific examples of criticality determination. Hereafter, description will be returned to a flow of risk determination.

Following the criticality determination of step S231, in step S232, it is determined whether the difference is a critical wiring line defect. If the difference is a critical wiring line defect, then risk determination finishes, and if the difference is not a critical wiring line defect, then processing is shifted to step S233.

Finally, in step S233, risk degree determination is executed for each difference. This step S233 includes steps S251 to S258 indicated below.

First, in step S251, a variable M is initialized to a certain value m. Now, the value m is a margin added to the difference occurring under a certain condition of the process condition, and so on. Note that in the case of simplifying the simulation, the value m may be a fixed value.

Then, in step S252, it is determined whether the difference has an open attribute. If the difference has an open attribute, then processing is shifted to step S253. On the other hand, if the difference has a short attribute, then processing is shifted to step S254.

Then, in step S253, an expanded difference having a margin region added to the difference having an open attribute, is generated. However, this margin region is added only inside the correct structure. In other words, the expanded difference has a structure of the difference thickened by an amount of the value M inside the correct structure.

On the other hand, in step S254, an expanded difference having a margin region added to the difference having a short attribute, is generated. However, this margin region is added only outside the correct structure. In other words, the expanded difference has a structure of the difference thickened by an amount of the value M outside the correct structure.

Then, in step S255, criticality determination of the expanded difference is executed. The criticality determination of the expanded difference of this step S255 is similar to the criticality determination of the difference of step S231.

Then, in step S256, it is determined whether the expanded difference is a critical wiring line defect. If the expanded difference is a critical wiring line defect, then processing is shifted to step S257. If the expanded difference is not a critical wiring line defect, then processing is shifted to step S258.

Then, in step S257, the variable M is changed to a new certain value m′. Now, the value m′ is a larger value than the value m. Subsequently, steps S252 to S257 are repeated until the expanded difference generated based on the new variable M becomes a critical wiring line defect.

Finally, in step S258, a risk degree for the difference based on the variable M is determined. Generally, the larger is the variable M, the greater is an allowance before reaching a critical wiring line defect, and the lower the risk degree of the difference is judged to be.

That concludes a flow of risk degree determination in step S233.

Now, risk degree determination will be described using several specific examples.

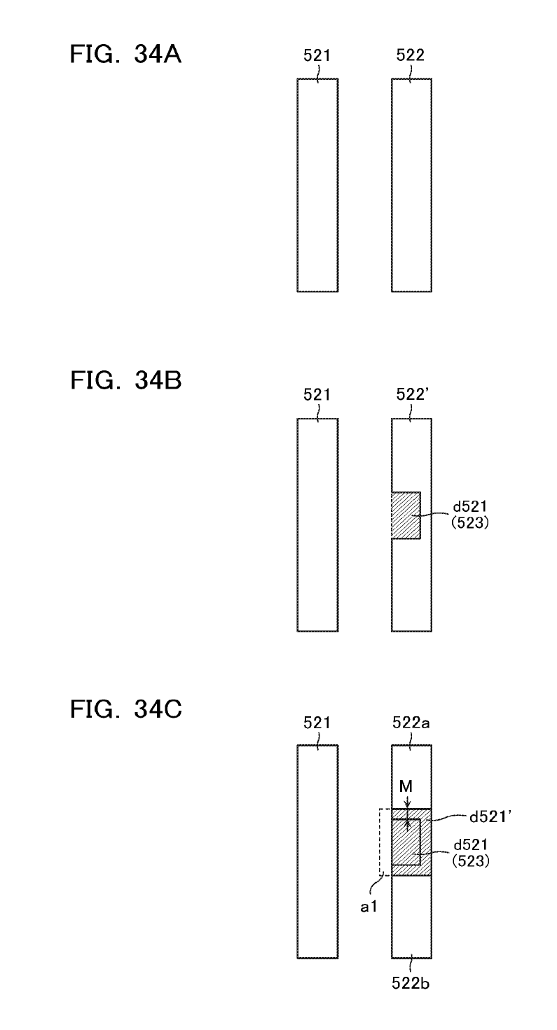

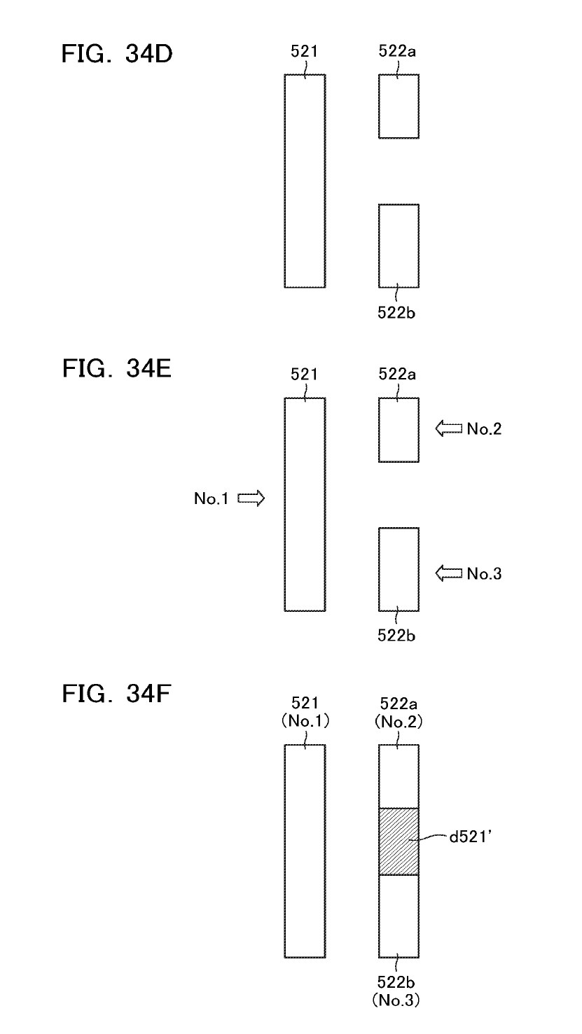

FIGS. 34A to 34F are an example of the case where the difference has an open attribute.

As shown in FIG. 34A, the correct structure of the semiconductor device includes two wiring lines 521 and 522 extending in parallel. As shown in FIG. 34B, the comparative structure of the semiconductor device, in contrast to the correct structure, includes a gap portion 523 gouging out part of the wiring line 522. This gap portion 523 is extracted as a difference d521. This difference d521 is inside the correct structure and is an open attribute. Therefore, as shown in FIG. 34C, an expanded difference d521′ attains a structure of the difference d521 thickened by an amount of the value M only inside the correct structure, without being thickened outside the correct structure (broken line portion a1 of FIG. 34C). As a result, in this case, as shown in FIG. 34D, the intermediate structure includes the wiring lines 521, 522a, and 522b. Now, the wiring lines 522a and 522b are the two portions divided by the expanded difference d521′. Moreover, an intermediate structure in risk degree determination refers to a difference set of the expanded difference subtracted from the sum-set of the correct structure and the comparative structure. As shown in FIG. 34E, the electrically unconnected wiring lines 521, 522a′, and 522b′ are respectively assigned with “No. 1”, “No. 2”, and “No. 3”. Finally, it is found that as shown in FIG. 34F, when the expanded difference d521′ is overlapped on the intermediate structure, the expanded difference d521′ contacts the wiring line 522a of “No. 2” and the wiring line 522b of “No. 3”. As a result, a determination to the effect that the difference d521 is a wiring line defect having a risk degree based on an M value, is made.

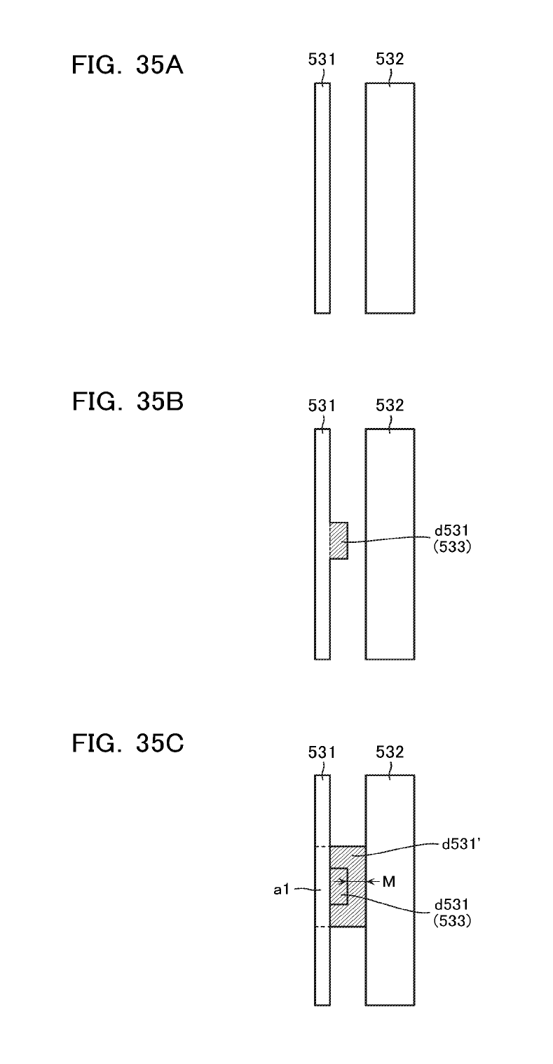

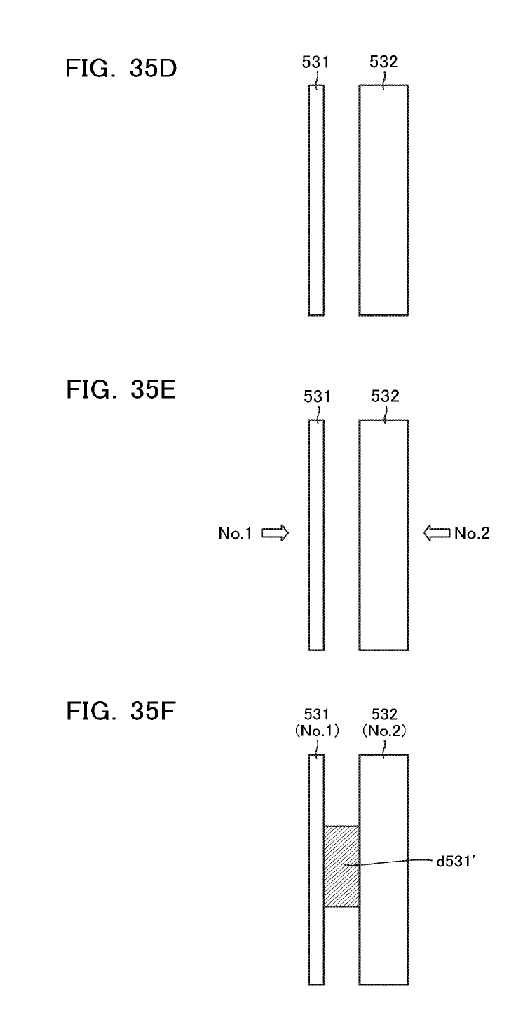

FIGS. 35A to 35F are an example of the case where the difference has a short attribute.

As shown in FIG. 35A, the correct structure of the semiconductor device includes a thin wiring line 531 and a thick wiring line 532 extending in parallel. As shown in FIG. 35B, the comparative structure of the semiconductor device, in contrast to the correct structure, includes a conductive portion 533 connected only to the wiring line 531, between the wiring lines 531 and 532. This conductive portion 533 is extracted as a difference d531. This difference d531 is outside the correct structure and is a short attribute. Therefore, as shown in FIG. 35C, an expanded difference d531′ attains a structure of the difference d531 thickened by an amount of the value M only outside the correct structure, without being thickened inside the correct structure (broken line portion a1 of FIG. 35C). As a result, in this case, as shown in FIG. 35D, the intermediate structure includes the wiring lines 531 and 532. As shown in FIG. 35E, the electrically unconnected wiring lines 531 and 532 are respectively assigned with “No. 1” and “No. 2”. Finally, it is found that as shown in FIG. 35F, when the expanded difference d531′ is overlapped on the intermediate structure, the expanded difference d531′ contacts the wiring line 531 of “No. 1” and the wiring line 532 of “No. 2”. As a result, a determination to the effect that the difference d531 is a wiring line defect having a risk degree based on an M value, is made.

That concludes the specific examples of risk degree determination. Hereafter, description will be returned to the flow of risk determination.

Following the risk determination of step S213, in step S214, it is determined whether the number n is smaller than a value N. Now, the value N is the number of partial differences. If n<N, then the number n is incremented in step S215, after which processing of steps S212 to S214 is repeated until n≧N.

That concludes a flow of the defect determination of step S203, and concludes a flow of the simulation method of the semiconductor device according to the present embodiment.

Using the simulation device and the simulation method according to the present embodiment makes it possible to extract not only a short defect but also an open defect of the wiring line structure. Furthermore, determination of whether a kind of the wiring line defect is an open defect or a short defect, determination of whether the wiring line defect is critical or not, and furthermore determination of a risk of the wiring line defect, are enabled. In other words, the present embodiment makes it possible for the wiring line structure of the semiconductor device to be analyzed in more detail compared to in the first embodiment.

### OTHERS

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A simulation device of a semiconductor device for analyzing a structural defect of the semiconductor device, the semiconductor device having a plurality of wiring lines disposed three-dimensionally therein, the simulation device of the semiconductor device comprising:
a correct structure acquiring unit that acquires a correct structure of the wiring lines of the semiconductor device;
a comparative structure acquiring unit that acquires a comparative structure, the comparative structure being a structure of the wiring lines of the semiconductor device manufactured under a certain condition;
a difference extracting unit that extracts a difference of the comparative structure with respect to the correct structure; and
a defect determining unit that determines a defect of the comparative structure from the difference,
the defect determining unit including an open/short attribute determining unit that determines whether the difference is an open attribute positioned inside the correct structure or a short attribute positioned outside the correct structure.

2. The simulation device of the semiconductor device according to claim 1, wherein
the defect determining unit determines the defect of the comparative structure for every partial difference, the partial difference being the difference divided into closed regions and further divided into being inside/outside the correct structure.

3. The simulation device of the semiconductor device according to claim 1, wherein
the defect determining unit includes a risk determining unit that determines a risk of an open defect or a short defect based on the difference.

4. The simulation device of the semiconductor device according to claim 3, wherein
the risk determining unit includes an intermediate structure acquiring unit that acquires an intermediate structure, the intermediate structure being a difference set of the difference subtracted from a sum-set of the correct structure and the comparative structure.

5. The simulation device of the semiconductor device according to claim 4, wherein
the risk determining unit includes a criticality determining unit that determines whether the difference contacts a plurality of electrically different wiring lines of the intermediate structure.

6. The simulation device of the semiconductor device according to claim 4, wherein
the risk determining unit includes a risk degree determining unit that determines whether an expanded difference being an outer periphery of the difference thickened by an amount of a certain value, contacts a plurality of electrically different wiring lines of the intermediate structure.

7. The simulation device of the semiconductor device according to claim 6, wherein
the certain value is calculated based on a process condition of the semiconductor device.

8. The simulation device of the semiconductor device according to claim 6, wherein
the certain value is a fixed value.

9. The simulation device of the semiconductor device according to claim 6, wherein
the risk determining unit, in the case that the difference is an open attribute positioned inside the correct structure, extracts the expanded difference being the outer periphery of the difference thickened by an amount of the certain value, only inside the correct structure.

10. The simulation device of the semiconductor device according to claim 6, wherein
the risk determining unit, in the case that the difference is a short attribute positioned outside the correct structure, extracts the expanded difference being the outer periphery of the difference thickened by an amount of the certain value, only outside the correct structure.

11. A simulation method of a semiconductor device for analyzing a structural defect of the semiconductor device, the semiconductor device having a plurality of wiring lines disposed three-dimensionally therein, the simulation method of the semiconductor device comprising:
acquiring a correct structure of the wiring lines of the semiconductor device;
acquiring a comparative structure, the comparative structure being a structure of the wiring lines of the semiconductor device manufactured under a certain condition;
extracting a difference of the comparative structure with respect to the correct structure; and
determining a defect of the comparative structure from the difference,
when determining the defect of the comparative structure, determining whether the difference is an open attribute positioned inside the correct structure or a short attribute positioned outside the correct structure.

12. The simulation method of the semiconductor device according to claim 11, further comprising:
when determining the defect of the comparative structure, determining a risk of an open defect or a short defect based on the difference.

13. The simulation method of the semiconductor device according to claim 12, further comprising:
when determining the risk of the open defect or the short defect, acquiring an intermediate structure, the intermediate structure being a difference set of the difference subtracted from a sum-set of the correct structure and the comparative structure.

14. The simulation method of the semiconductor device according to claim 13, further comprising:
when acquiring the intermediate structure, determining whether the difference contacts a plurality of electrically different wiring lines of the intermediate structure.

15. The simulation method of the semiconductor device according to claim 13, further comprising:
when determining the risk of the open defect or the short defect, determining whether an expanded difference being an outer periphery of the difference thickened by an amount of a certain value, contacts a plurality of electrically different wiring lines of the intermediate structure.

16. A simulation device of a semiconductor device for analyzing a structural defect of the semiconductor device, the semiconductor device having a plurality of wiring lines disposed three-dimensionally therein, the simulation device of the semiconductor device comprising:
a correct structure acquiring unit that acquires a correct structure of the wiring lines of the semiconductor device;
a structure-to-be-analyzed generating unit that generates a structure-to-be-analyzed being outer peripheries of the plurality of wiring lines of the correct structure thickened by an amount of a certain value; and
a defect determining unit that determines a defect by whether a plurality of electrically different fellow wiring lines of the structure-to-be-analyzed have an overlapping place.

17. The simulation device of the semiconductor device according to claim 16, wherein
the certain value is calculated based on a process condition of the semiconductor device.

18. The simulation device of the semiconductor device according to claim 16, wherein
the certain value is a fixed value.
